(19) United States
(12) Patent Application Publication
(10) Pub. No.: US 2024/0406806 A1
(43) Pub. Date: Dec. 5, 2024

(54) L2/L3 CONTROL PLANE ROBUSTNESS FOR L1/L2 MOBILITY USING MULTI-TRP OPERATION

(71) Applicant: Nokia Technologies Oy, Espoo (FI)

(72) Inventors: Subramanya CHANDRASHEKAR, Bangalore (IN); Andres ARJONA, Tokyo (JP); Tero HENTTONEN, Espoo (FI)

(21) Appl. No.: 18/701,588

(22) PCT Filed: Aug. 30, 2022
(86) PCT No.: PCT/EP2022/074087

§ 371 Date: Apr. 15, 2024

(30) Foreign Application Priority Data
Oct. 20, 2021 (IN) 202141047614

(51) Int. Cl. H04W 36/00; H04W 28/06; H04W 36/08

(52) U.S. Cl. CPC H04W 36/0007; H04W 28/06; H04W 36/08

(57) ABSTRACT

A user equipment configured to: store a L2 and/or L3 multicast capability, wherein a L2 multicast operation enables the user equipment to receive a first L2 message from a first network node, and a second L2 message from a second network node, wherein a payload of second message is a duplicate of a payload of the first message, and wherein a L3 multicast operation enables the user equipment to receive a third L3 message from a third network node, and a fourth L3 message from a fourth network node, wherein a payload of fourth message is a duplicate of a payload of third message, transmit the L2 and/or L3 multicast towards the first or third node, receive a message from the first or third node, wherein the message includes an indication to activate the L2 and/or L3 multicast, and activate the L2 and/or L3 multicast based on the message.

### TECHNICAL FIELD

The examples and non-limiting embodiments relate generally to communications and, more particularly, to L2/L3 control plane robustness for L1/L2 mobility using multi-TRP operation.

### BACKGROUND

It is known to implement a plurality of radio access network nodes in a communication network.

### SUMMARY

In accordance with an aspect, an apparatus includes at least one processor; and at least one memory including computer program code; wherein the at least one memory and the computer program code are configured to, with the at least one processor, cause the apparatus at least to: transmit, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; in response to the first network node hosting at least the cell also hosting at least one assisting cell, transmit a message comprising a radio resource control payload to the first network node hosting at least the cell; and in response to the first network node hosting at least the cell not hosting the at least one assisting cell, transmit the message comprising the radio resource control payload to the first network node hosting at least the cell, and transmit another message comprising the radio resource control payload to a second network node hosting the at least one assisting cell.

In accordance with an aspect, a user equipment includes at least one processor; and at least one memory including computer program code; wherein the at least one memory and the computer program code are configured to, with the at least one processor, cause the user equipment at least to: receive a configuration from a first network node or a third network node indicating that the user equipment is to support layer 2 multicast operation or layer 3 multicast operation; wherein the configuration indicates functionality for detecting a copy of a layer 2 or layer 3 message is received, and for discarding the copy; wherein the copy is received from a non-serving cell; activate in downlink or uplink or both, layer 2 multicast operation or layer 3 multicast operation, based on the received configuration; receive multicast data, and process the multicast data; and transmit either an acknowledgement or negative acknowledgement whether the multicast data was successfully received and processed; wherein the acknowledgement or negative acknowledgement is transmitted to the first network node, a second network node, or the third network node; wherein the first network node is hosting a serving cell, and the second network node is hosting at least one assisting cell.

In accordance with an aspect, a user equipment includes at least one processor; and at least one memory including computer program code; wherein the at least one memory and the computer program code are configured to, with the at least one processor, cause the user equipment at least to: store a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message, transmit the L2 and/or L3 multicast operation capability towards the first or third network node, receive a control message from the first or third network node, wherein the control message includes an indication to the user equipment to activate the L2 and/or L3 multicast operation depending on its capability, and activate the L2 and/or L3 multicast operation based on the control message.

In accordance with an aspect, a method includes transmitting, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; in response to the first network node hosting at least the cell also hosting at least one assisting cell, transmitting a message comprising a radio resource control payload to the first network node hosting at least the cell; and in response to the first network node hosting at least the cell not hosting the at least one assisting cell, transmitting the message comprising the radio resource control payload to the first network node hosting at least the cell, and transmitting another message comprising the radio resource control payload to a second network node hosting the at least one assisting cell.

In accordance with an aspect, a method includes receiving a configuration from a first network node or a third network node indicating that the user equipment is to support layer 2 multicast operation or layer 3 multicast operation; wherein the configuration indicates functionality for detecting a copy of a layer 2 or layer 3 message is received, and for discarding the copy; wherein the copy is received from a non-serving cell; activating in downlink or uplink or both, layer 2 multicast operation or layer 3 multicast operation, based on the received configuration; receiving multicast data, and processing the multicast data; and transmitting either an acknowledgement or negative acknowledgement whether the multicast data was successfully received and processed; wherein the acknowledgement or negative acknowledgement is transmitted to the first network node, a second network node, or the third network node; wherein the first network node is hosting a serving cell, and the second network node is hosting at least one assisting cell.

In accordance with an aspect, a method includes storing a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message, transmitting the L2 and/or L3 multicast operation capability towards the first or third network node, receiving a control message from the first or third network node, wherein the control message includes an indication to the user equipment to activate the L2 and/or L3 multicast operation depending on its capability, and activating the L2 and/or L3 multicast operation based on the control message.

In accordance with an aspect, a non-transitory program storage device readable by a machine, tangibly embodying a program of instructions executable with the machine for performing operations is provided, the operations comprising: transmitting, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; in response to the first network node hosting at least the cell also hosting at least one assisting cell, transmitting a message comprising a radio resource control payload to the first network node hosting at least the cell; and in response to the first network node hosting at least the cell not hosting the at least one assisting cell, transmitting the message comprising the radio resource control payload to the first network node hosting at least the cell, and transmitting another message comprising the radio resource control payload to a second network node hosting the at least one assisting cell.

In accordance with an aspect, a non-transitory program storage device readable by a machine, tangibly embodying a program of instructions executable with the machine for performing operations is provided, the operations comprising: receiving a configuration from a first network node or a third network node indicating that the user equipment is to support layer 2 multicast operation or layer 3 multicast operation; wherein the configuration indicates functionality for detecting a copy of a layer 2 or layer 3 message is received, and for discarding the copy; wherein the copy is received from a non-serving cell; activating in downlink or uplink or both, layer 2 multicast operation or layer 3 multicast operation, based on the received configuration; receiving multicast data, and processing the multicast data; and transmitting either an acknowledgement or negative acknowledgement whether the multicast data was successfully received and processed; wherein the acknowledgement or negative acknowledgement is transmitted to the first network node, a second network node, or the third network node; wherein the first network node is hosting a serving cell, and the second network node is hosting at least one assisting cell.

In accordance with an aspect, a non-transitory program storage device readable by a machine, tangibly embodying a program of instructions executable with the machine for performing operations is provided, the operations comprising: storing a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message, transmitting the L2 and/or L3 multicast operation capability towards the first or third network node, receiving a control message from the first or third network node, wherein the control message includes an indication to the user equipment to activate the L2 and/or L3 multicast operation depending on its capability, and activating the L2 and/or L3 multicast operation based on the control message.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 is a block diagram illustrating a disaggregated gNB architecture, based on the examples described herein.

FIG. 3 is a diagram illustrating L1/L2 centric inter-cell mobility scenarios.

FIG. 4 is a signaling diagram for various embodiments described herein.

FIG. 5 is a signaling diagram for CP/UP bi/multicasting.

FIG. 6 is an example apparatus configured to implement the examples described herein.

FIG. 7 is a block diagram illustrating L2/L3 signaling, based on the examples described herein.

FIG. 8 is an example method to implement the examples described herein.

FIG. 9 is an example method to implement the examples described herein.

FIG. 10 is an example method to implement the examples described herein.

### DETAILED DESCRIPTION OF EXAMPLE EMBODIMENTS

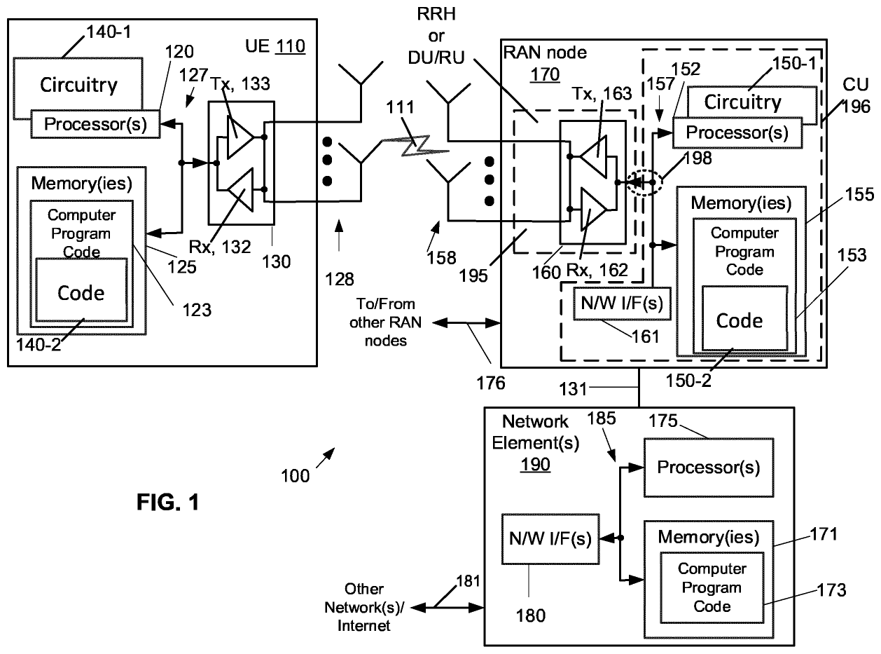

Turning to FIG. 1, this figure shows a block diagram of one possible and non-limiting example of an illustration of a wireless network 100 in which the examples may be practiced. A user equipment (UE) 110, a radio access network (RAN) node 170, and a network element(s) 190 are illustrated. In the example of FIG. 1, the user equipment (UE) 110 is in wireless communication with RAN node 170. A UE is a device with a radio interface to access the wireless network 100. The UE 110 includes e.g. one or more processors 120, one or more memories 125 (with computer program code stored thereon), and one or more transceivers 130 interconnected through one or more buses 127 or other wired connections. At least one of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. At least one of the one or more transceivers 130 is connected to at least one or more antennas 128. At least one of the one or more memories 125 includes computer program code 123. The UE 110 includes circuitry 140-1 and/or code 140-2, which may be implemented in a number of ways. The circuitry 140-1 may be implemented in hardware, such as being implemented as part of the one or more processors 120. The circuitry 140-1 may be implemented also as an integrated circuit or through other hardware such as a programmable gate array. In another example, code 140-2, may be implemented as computer program code 123 and is executable by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless or radio link 111. Circuitry 140-1 and/or code 140-2 may provide L2 and/or L3 functionality, e.g. L2 and/or L3 control plane signal processing.

The RAN node 170 in this example is a base station that provides access to the UE 110. The RAN node 170 may be, for example, a base station for 5G, also called New Radio (NR). In 5G, the RAN node 170 may be a NG-RAN node, e.g. a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs. A gNB may include a central unit (CU) (gNB-CU) 196 and one or more distributed unit(s) (DUs) (gNB-DUs), of which DU 195 is shown. Note that the DU 195 may include or be coupled to and control a radio unit (RU). The gNB-CU 196 is a logical node which may host radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node which may host RLC, MAC and PHY layers of the gNB or en-gNB, and its operation is partly controlled by gNB-CU 196. One gNB-DU 195 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the gNB-DU 195 may include at least one processor and at least one memory with computer program code stored thereon, and the transceiver 160, e.g., as part of a Radio Unit (RU), but some examples of this may have the transceiver 160 as part of a separate RU, e.g., under control of and connected to the gNB-DU 195. The one or more transceivers 160 are connected to one or more antennas 158. The gNB-DU 195 may further include circuitry and/or code which may provide L2 functionality, e.g. L2 control plane signal processing. The RAN node 170 may also be an eNB (evolved NodeB) base station, for LTE (long term evolution), or any other suitable base station or node.

The gNB-CU 196 (and/or RAN node 170) may include one or more processors 152, one or more memories 155, one or more network interfaces (N/W I/F(s)) 161, interconnected through one or more buses 157 or other wired connections. At least one of the one or more memories 155 includes computer program code 153, e.g. computer-readable instructions. Note that the DU 195 may also contain its own memory/memories and processor(s), and/or other hardware.

The RAN node 170 (and/or CU 196 and/or DU 195) includes circuitry 150-1 and/or code 150-2, which may be implemented in a number of ways. The circuitry 150-1 may be implemented in hardware, such as being implemented as part of the one or more processors 152. The circuitry 150-1 may be implemented also as an integrated circuit or through other hardware such as a programmable gate array. In another example, code 150-2, may be implemented as computer program code 153 and is executable by the one or more processors 152. For instance, the one or more memories 155 and the computer program code 153 may be configured to, with the one or more processors 152, cause the gNB-CU 196 (and/or RAN node 170 and/or DU 195) to perform one or more of the operations as described herein. Circuitry 150-1 and/or code 150-2 may provide L3 functionality, e.g. L3 control plane signal processing.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

Accordingly, UE 110, RAN node 170, and/or network element(s) 190, (and associated memories, computer program code and modules) may be configured to implement (e.g. in part) the examples described herein, including L2/L3 control plane robustness for L1/L2 mobility, using multi-TRP operation. Thus, computer program code 123, circuitry 140-1, code 140-2, and other elements/features shown in FIG. 1 of UE 110 may be configured to implement user equipment related aspects of the examples described herein. Similarly, computer program code 153, circuitry 150-1, code 150-2, and other elements/features shown in FIG. 1 of RAN node 170 (and/or CU 196 and/or DU 195) may be configured to implement RAN/gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

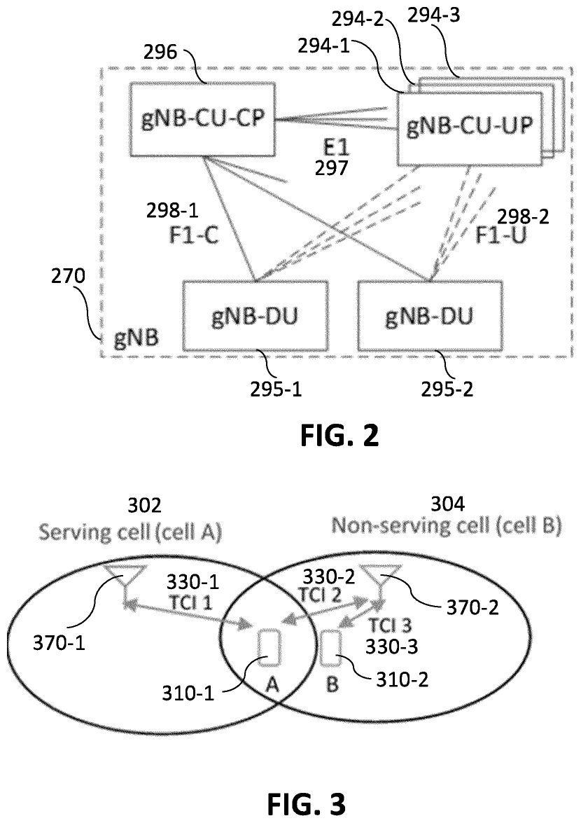

With reference to FIG. 2, the disaggregated architecture is defined in 3GPP decomposing the gNB 270 e.g. into multiple logical entities. Likewise, a single DU may host multiple cells (max of 512 in current specifications). In an exemplary embodiment the gNB-CU-CP 296 hosts the PDCP(c) and RRC layers, while the gNB-DU (295-1 and 295-2) hosts the RLC, MAC and PHY layers. The scheduling operation takes place at the gNB-DU (295-1, 295-2). The gNB-CU-UP hosts the PDCP(u) and SDAP layers.

FIG. 2 further shows the gNB-CU-CP 296 connected to each of the gNB-DU (295-1, 295-2) via a plurality of respective F1-C interfaces (collectively 298-1), and the gNB-CU-CP 296 connected to a plurality of gNB-CU-UPs (294-1, 294-2, 294-3) via a plurality of respective E1 interfaces (collectively 297). Each gNB-DU (295-1, 295-2) is connected to each of gNB-CU-UP 294-1, gNB-CU-UP 294-2, and gNB-CU-UP 294-3 via a plurality of respective F1-U interfaces (collectively 298-2).

Likewise, any given cell may consist of multiple beams served by different transmission points (TRPs). As of Release 16, it is possible for a UE to transmit and receive data via multiple beams as long as these belong to the same cell (i.e. same PCI).

With reference to FIG. 3, there is an ongoing Release 17 RAN1-led NR_feMIMO work item in 3GPP, which extends the multiTRP (mTRP) operation to support transmission and reception of multiple beams from different cells, with limitation that these cells must belong to the same gNB-DU. Likewise, potential change of the serving cell via L1/L2 mechanisms is out of scope in release 17.

FIG. 3 shows an example of an mTRP scenario. In FIG. 3, TCI 1 (330-1) is transmitted between the UE A (310-1) and TRP 370-1 located in the serving cell (cell A) 302. TCI 2 (330-2) is transmitted between UE A 310-1 and TRP 370-2 located in the non-serving cell (cell B) 304. TCI 3 (330-3) is transmitted between UE B 310-2 and TRP 370-2 located in the non-serving cell (cell B) 304. A serving cell is associated with a UE, i.e., any cell becomes a serving cell when it serves a UE.

Although Release 17 is limited to intra-DU mTRP operation, there is significant operator and vendor demand to continue further work in Rel 18 with a broader scope and is likely to be agreed to as well. This would extend the support also for change of serving-cell via L1/L2 based mechanisms in both intra-DU and inter-DU scenarios.

In order to support L1/L2 centric inter-cell change (i.e. change of serving cell) in the disaggregated gNB architecture, a new mechanism is needed in which configuration would be generated and delivered by the gNB-CU-CP, but executed autonomously by the gNB-DU without further interaction with the upper layers.

A solution to realize control plane signaling robustness for L1/L2 centric mobility is crucial to ensure success of the new mobility concept.

To support C-plane signaling robustness in cellular networks, a prominent solution that has been employed is to make use of a second radio link whenever available, i.e. bi-casting or transmitting the C-plane signaling (UL/DL or both) via one or more radio links configured for the UE.

HSPA Multiflow (3G): the multiflow feature allows the UE in softer or soft handover regions to be served by both the serving and the non-serving cell (assisting serving cell) on the same frequency at the same time. The most simple configuration or flavor of HSPA multiflow is SF-DC (single frequency, dual cell) HSDPA multiflow. SFDC-HSDPA Multiflow operates on one carrier frequency and allows scheduling of two independent data streams to the UE from two different sectors on one carrier frequency. The network can configure the UE to receive C-plane signaling on both radio links, associated with serving and assisting cells.

There are multiple other variants of HSPA MF, including ones where MF is configured in UL. Bi-casting can be enabled in all the configurations, as mentioned above.

Multi-RAT/New Radio Dual Connectivity (MR-DC, NR-DC): MR-DC is the general term given to a range of different dual connectivity configuration options, largely associated with 5G. With MR-DC, the master RAN Node functions as the controlling entity, utilizing a secondary RAN for additional data capacity. Dual connectivity (DC) allows a UE to simultaneously transmit and receive data on multiple component carriers from two serving nodes or cell groups (a master node, MN, and a secondary node, SN). Both MN and SN configure their own RRC entities for a DC UE and bi-casting here amounts to transmitting either node RRC signaling (MN or SN) over RRC interfaces of both i.e. radio links of both the MN and SN to transmit RRC messages of MN/SN.

All variants of DC support this bi-casting configuration, regardless of whether or not the concept is referred to by the same name.

PDCP Duplication/Multiplication for Control-Plane: introduced for 5G NR in Rel 15-16, PDCP duplication/multiplication for control-plane allows transmitting and receiving multiple copies of the RRC messages between the gNB and the UE. This however also results in having multiple copies of the same data traversing between the gNB-CU-CP and the gNB-DU(s) regardless of the contents being the same. These messages also incur multiple copies over the air interface. Release 15 supports duplication (i.e. two copies of the message), while Release 16 supports up to four copies (i.e. multiplication). Further, each message instance is sent to the UE over a different carrier frequency.

In relation to the 3GPP L1/L2-centric mobility work items in Rel 17 and Rel 18, the solutions available for bi-casting and PDCP duplication described above are not directly applicable for L1/L2 mobility and a different mechanism is required. The following are some of these reasons (A-D immediately following).

A. The CU-CP is the originator of RRC signaling. Since the DU is responsible for execution of mTRP operation and L1/L2 based mobility, the CU-CP needs to notify the DU to activate/deactivate the bi/multi-casting on a per UE basis (particularly targeting HO command), without which the DU hosting the serving and assisting cells may not even have the awareness to perform bicasting. Likewise, this differs from PDCP duplication/multiplication as only a single instance (as opposed to multiple copies) of the RRC message needs to be transferred between the CU-CP and the DU.

B. There are at least two originators of control-signaling at different protocol layers. The CU-CP which originates the L3 RRC signaling, and the DU which originates the L2 MAC CE for L1/L2 HO (e.g.: serving cell change or HO command, assisting cell change, stop/start mTRP operation etc.). Both of them are eligible for bi/multi-casting, but need clear indication from the CU-CP regarding what is included for bicasting and what is not.

C. Since there is no duplicate detection and discarding (as in higher layers) for L2 control signaling (MAC CE), the UE needs to be able to identify duplicate control signaling and discard signaling whenever applicable.

D. Lastly, since both mTRP and L1/L2 based mobility are possible for both intra-DU and inter-DU, bi/multi-casting for L2 control signaling demand differential handling in either case, as there are two MAC packet schedulers (PSs) handling the inter-DU mTRP scenario.

Accordingly, the herein described examples include the following embodiments.

Described herein is a mechanism to indicate and configure over the F1 interface whether activation of bi/multicast operation is applicable to control plane signaling of L3, L2 or both at the DU. Herein, multicast may include bicast, e.g. multicasting may include bicasting. The CU provides an indication (e.g., via a flag) to the DU to bi/multi-cast control plane signaling over the serving cell TRPs and assisting cell TRPs. This feature can operate at two levels: (a) bi/multi-cast of the L3 RRC messages via multiple beams of different cells, and (b) bi/multi-cast of the L2 MAC CE scheduling commands. A possible structure for this indication over F1 would comprise of an IE which includes sub-elements or bits indicating whether L2 or L3 bi/multi-cast is to be carried out. In its simplest form (two TRPs), L3 and L2 messages would be duplicated over the air interface and sent over an additional TRP (beam). However in case of mTRP with “N” (i.e. multiple) links, this functionality could incur further copies of the message via N×TRPs (multi-cast) without any changes in the main concept described herein. Regarding the case of mTRP with “N” (i.e. multiple) links, the number of assisting cells configured for a UE could be N where N is more than 1. Each assisting cell may transmit a copy of the message content transmitted on the serving cell. Although the CU could explicitly indicate the number of copies to be sent over the air interface to the DU, it is also possible that the DU autonomously determines over which and how many TRPs based on signal conditions and load factors in the cell under its control.

If the UE supports this feature capability, further described herein is a mechanism to configure at the UE the bi/multi-cast operation at L3, L2 or both, as well as the data direction (DL only, UL only, or both). When in use, the UE requires functionality to detect when multiple copies of the L3 or L2 messages are received over the air interface and discard the copies of already successfully received messages. This is proposed to be done via existing message identifiers (e.g. RRC transaction ID, specific MAC CE, use MAC LCID, etc.) or via additional elements added to the packet headers (e.g. use of R-bit in the protocol header, use of a certain logical channel ID (LCID), additional RRC field, etc.). If UL bi/multi-cast is activated at a given UE, duplicate detection and discard is required at the network side as well. This is different for intra-DU and inter-DU scenarios. In the intra-DU scenario, the duplicate detection can be performed at the MAC layer at the DU. The DU requires a function to detect and discard duplicated copies received over the air interface and transmit a single copy over F1 toward the CU. This is proposed to be done via existing elements (e.g. PDCP SN, DCI bits, etc.) or via additional elements added to packet headers or L1 signaling (e.g. a new bit in a DCI-field, use of an R-bit in the protocol header, etc.). In the inter-DU scenario, the duplicate detection has to be performed at the CU-CP.

Duplicate detection scenarios at UE: (1) In one scenario, the UE receives an original first message from a serving cell, then a duplicate message from an assisting cell. The UE processes the original message, sends an ACK to the serving DU, discards the duplicate message, and sends an ACK to the assisting DU. (2) In another scenario, the UE receives the duplicate message first from the assisting cell, then receives the original message from the serving cell. The UE processes the duplicate message, sends an ACK to the assisting DU, discards the original message, and sends an ACK to the serving DU. The UE may also indicate to both the serving and assisting DU that the duplicate was received before the original. (3) In another scenario, the UE receives only the duplicate message from the assisting cell, and no original message from the serving cell. The UE processes the duplicate message, and sends an ACK to the assisting DU. The UE may also indicate to both the serving and assisting DU that the original message was not received.

In the first case, there is no need to indicate to the serving/assisting DU whether the duplicate/original was received, as both receive the ACK anyway. But that may still be done to distinguish the general case so such an “ACK report” may be sent to the CU (who is the originator of L3 messages). Such additional information sent by the UE can be used in intelligence gathering for AI-ML algorithms, for example, to determine when to enable bicasting, to determine what kind of DUs (frequency, cell size etc.) are eligible for bicasting, etc. One or more UE reports indicating a cell where either an original or duplicate message was not received is considered eligible for bicasting. One or more UE reports indicating a particular message type, e.g. a handover command, was not delivered either at the serving cell or at the assisting cell associated with mTRP operation may indicate that the particular message should be considered for bicasting.

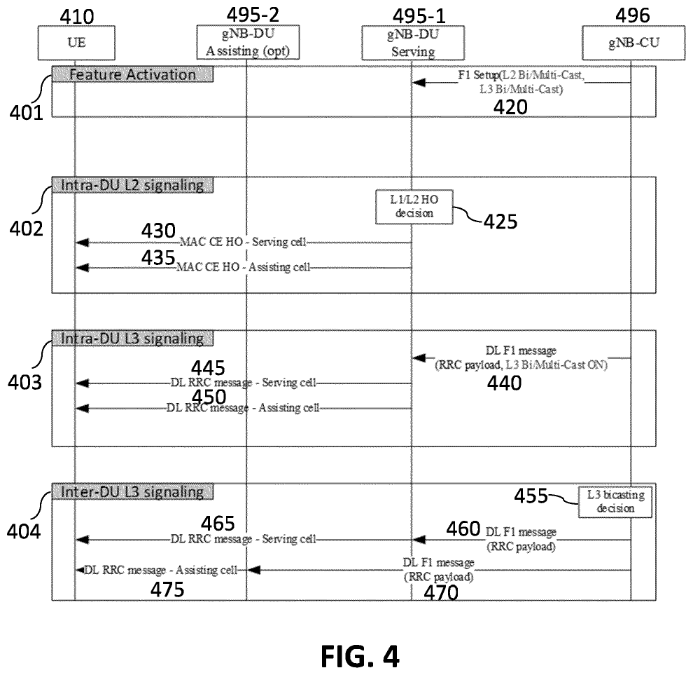

The impacts to the different entities involved can be modelled as shown in FIG. 4.

With reference to FIG. 4, at 401, bi/multi-cast feature activation over F1 occurs between various entities, including between the UE 410, the assisting gNB-DU 495-2, the serving gNB-DU 495-1, and the gNB-CU 496. Feature activation 401 includes at 420, the gNB-CU 496 transmitting an F1 setup message to the serving gNB-DU 495-1, where the F1 setup message includes activation information for L2 bi/multi-cast or an L3 bi/multi-cast. This activation can be deactivated or reactivated using an F1 CU configuration update message.

With regard to activation, this feature is carried out on a per UE basis. However, configuration of the feature itself could be based on indicating the UEs for which to apply the feature, or alternatively, the conditions (e.g., which specific L3 messages) the feature should be applicable to and the conditions applicable to all UEs supporting this capability. Therefore, the CU 496 to DU 495-1 signaling (420) can be specified by both a UE associated procedure as well as a non-UE associated procedure. For both options, it is possible to reuse existing messages, as well as introduce new ones.

Option 1—UE associated procedure: the CU 496 activates the feature for the UE to which this message bicasting is associated. This could be implemented by introducing new IEs to the existing UE CONTEXT MODIFICATION REQUEST message or via specifying a new message to convey this information (e.g., C-PLANE ROBUSTNESS REQUEST). For example, an information element in each UE-associated F1 message L3 bi/multi-cast (ON, OFF) may be used.

Option 2—Non-UE associated procedure: the CU 496 indicates via a general message the list of UEs for which the feature needs to be activated/deactivated, or the type of messages that the feature is applicable to (e.g., specific L3 messages). In this case, this could be implemented by introducing new IEs to the existing GNB-CU CONFIGURATION UPDATE message, or via specifying a new message to convey this information (e.g., C-PLANE ROBUSTNESS CONFIGURATION UPDATE). For example, information elements L2 bi/multi-cast (activate, deactivate), L3 bi/multi-cast (activate, deactivate), or Message (all, mobility, . . . ) may be used.

It is also possible to adopt both Option 1 and Option 2 described above.

The bi/multi-cast feature operation is described with further reference to FIG. 4, including intra-DU L2 signaling 402, intra-DU L3 signaling 403, and inter-DU L3 signaling 404.

The intra-DU scenario (serving and assisting cells belong to the same DU) is shown as items 402 and 403.

L2 control signaling (402): based on the configuration, the DU 495-1 transmits the MAC CE (L2 control signaling) associated with mTRP operation, an L1/L2 based serving cell change or any MAC CE in general, from both serving and N× assisting cells. As shown, at 425 the serving gNB-DU 495-1 makes an L1/L2 HO decision. At 430, the serving gNB-DU 495-1 transmits the MAC CE HO signal from the serving cell to the UE 410. At 435, the serving gNB-DU 495-1 transmits the MAC CE HO signal from one or more assisting cells to the UE 410. The signals sent at 430 and 435 are generated at the serving gNB-DU 495-1. This is one exemplary case of applying bicasting to a selected message like a MAC CE based HO command.

L3 control-plane signaling (403): based on the FLAG indication from CU-CP in the F1 message (440), the DU 495-1 transmits the RRC payload via radio links of both serving and N× assisting cells. Thus, at 440 the gNB-CU 496 transmits a DL F1 message to the serving gNB-DU 495-1, the DL F1 message comprising an RRC payload and an L3 bi/multi-cast ON flag. Based on the L3 bi/multi-cast ON flag, the serving gNB-DU 495-1 transmits the messages at 445 and/or 450. At 445, the serving gNB-DU 495-1 transmits a DL RRC message to the UE 410, the DL RRC message including the RRC payload of the serving cell, where the DL RRC message transmitted at 445 is scheduled using resources of the serving cell, and where the DL RRC message transmitted at 445 was generated by and received from the gNB-CU 496. At 450, the serving gNB-DU 495-1 transmits a DL RRC message to the UE 410, the DL RRC message including the RRC payload of one or more assisting cells, where the DL RRC message transmitted at 450 is scheduled using resources of the one or more assisting cells, and where the DL RRC message transmitted at 450 was generated by and received from the gNB-CU 496. The message transmitted at 450 is a copy of the message transmitted at 445.

The inter-DU scenario (serving and assisting cells belong to different DUs) is shown as item 404.

L3 control-plane signaling (404): the CU-CP 496 may itself decide (at 455) when to activate bi/multi-casting, depending on the L3 message (e.g., selectively enabled for specific messages, such as HO command). Subsequently, the selected RRC message could be sent to both DUs (hosting serving and assisting cells). Thus, as shown, at 460 the gNB-CU 496 transmits a DL F1 message including an RRC payload to the serving gNB-DU 495-1, and at 465, the serving gNB-DU 495-1 transmits a serving cell DL RRC message to the UE 410. At 470, the gNB-CU 496 transmits a DL F1 message including an RRC payload to the assisting gNB-DU 495-2, and at 475, the assisting gNB-DU 495-2 transmits an assisting cell DL RRC message to the UE 410.

L2 control signaling: since the L2 control signaling is originated by the serving DU and the assisting cell(s) is hosted by a different DU, bi-casting for L2 control signaling is not feasible in this case (MAC-PS being different) in the current setup as there is no standardized mechanism to convey communication between schedulers at different DUs. However, if there is a DU-DU interface introduced in future (5G or 6G), or implemented via proprietary means (as in the inter-site carrier aggregation feature in LTE), the L2 control signaling shall be transmitted to the DU hosting the assisting cell (via a DU-DU interface) to actuate bi-casting via an assisting radio link.

DU to UE communication over air interface MAC information (e.g. MAC CE or MAC LCID, i.e. L2 signaling) is proposed to indicate if the signaling is a duplicate. A new MAC CE could be piggybacked with the message, or a specific LCID could be reserved for the message sent with duplication, or even a new bit could be introduced to the MAC header. The MAC CE could be sent from the cells sending the duplicated message, e.g. the MAC CE from the serving cell may not set this 1-bit indicator, while the 1-bit indicator is set for the MAC CE from the assisting cell to indicate it's a duplicate.

UE aspects (duplicate detection and discard) of L3 control-plane signaling may include a duplicate detection and discard mechanism using the RRC transaction ID. However, an additional field could also be used in case additional granularity is needed (as only 4 RRC transaction IDs are currently enabled). UE aspects (duplicate detection and discard) of L2 control signaling may be such that duplicate detection and discard is performed based on the 1-bit indicator in the MAC signaling.

The following are possible embodiments of UE capability (i-iii): i) 2 new bits indicating support for L2 bi/multicast in UL or DL (i.e. 1 bit for UL, 1 for DL)—used at the DU; ii) 2 new bits indicating support for L3 bi/multicast in UL or DL (i.e. 1 bit for UL, 1 for DL)—used at the CU; iii) optionally, 2 additional new bits indicating support for L2/L3 bi/multicast for both UL/DL (signaling optimization in case the UE supports UL+DL for both L2/L3 at the same time).

Notification to CU-CP. In both intra-DU and inter-DU cases (including 402, 403, and 404), the CU-CP 496 may configure the DU hosting the assisting cell (e.g. 495-2) to remember the message transmitted to the UE 410 (e.g., using a transaction ID) and to send a DL delivery notification to the CU-CP 496 once the message has been delivered to the UE 410 (e.g., for a L3 HO message). This could be used for AI-ML purposes, e.g., to learn when (which L3/L3 signaling) to activate bi-casting.

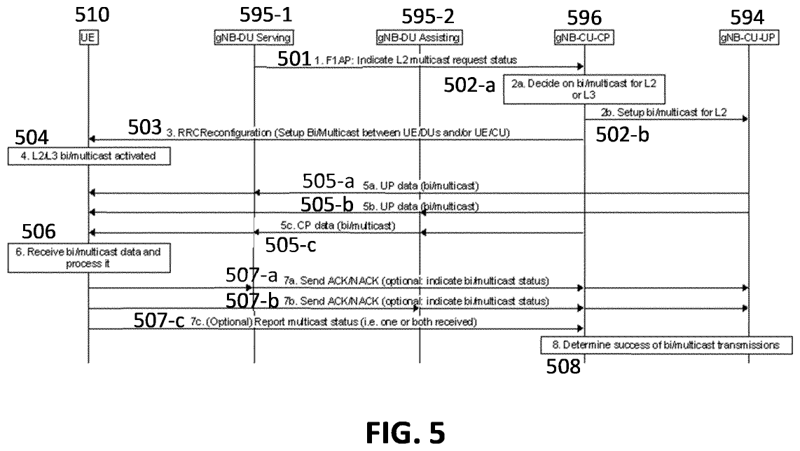

FIG. 5 also illustrates the basic procedure of configuring the duplicate detection at the UE.

At step 1 (501), DUs indicate that they support the multicast operation, after which CU-CP configures it for CU-UP and the DUs in steps 2 (502-a, 502-b) and 3 (503). After step 4 (504), the UE 510 has the bi/multicast activated and receives UP/CP data accordingly in step 5 (505-a, 505-b, 505-c), processing the UP/CP data in step 6 (506). At step 7a/b/c (507-a, 507-b, 507-c), the UE 510 indicates the reception status to the transmitting entity (at least the DUs for L2, optionally also to the CU, and the CU-CP for L3), after which CU-CP/CU-UP may adjust (at 508) the choice of bi/multicast based on the success of the operation. FIG. 5 also includes bi/multicast of UP data (when enabled).

Accordingly, as shown in FIG. 5, at 501 the serving gNB-DU 595-1 indicates in an F1AP message an L2 multicast request status to the gNB-CU-CP 596. The gNB-CU-CP is assumed to have requested a resource availability status when deciding to enable bicasting for user-plane. At 502-a, the gNB-CU-CP 596 decides on bi/multi-cast for L2 and/or L3. At 502-b, the gNB-CU-CP 596 transmits information to setup bi/multicast for user plane to the gNB-CU-UP 594. At 503, the gNB-CU-CP 596 transmits an RRC reconfiguration message to the UE 510, the RRC reconfiguration message comprising a setup bi/multicast between UE/DUs and/or the UE/CU. At 504, the UE activates L2/L3 bi/multicast.

At 505-a, the gNB-CU-UP 594 transmits UP data (bi/multicast) to the serving gNB-DU 595-1, and the serving gNB-DU 595-1 transmits the UP data to the UE 510. At 505-b, the gNB-CU-UP 594 transmits UP data (bi/multicast) to the assisting gNB-DU 595-2, and the assisting gNB-DU 595-2 transmits the UP data (bi/multicast) to the UE 510. At 505-c, the gNB-CU-CP 596 transmits CP data (bi/multicast) to the assisting gNB-DU 595-2, the assisting gNB-DU 595-2 transmits the CP data (bi/multicast) to the serving gNB-DU 595-1, and the serving gNB-DU 595-1 transmits the CP data (bi/multicast) to the UE 510. At 506, the UE 510 receives the bi/multicast data and processes the bi/multicast data.

At 507-a, the UE 510 transmits an ACK/NACK (including optionally indicating bi/multicast status) to the serving gNB-DU 595-1, the serving gNB-DU 595-1 transmits an ACK/NACK (including optionally indicating bi/multicast status) to the gNB-CU-CP 596, and the gNB-CU-CP 596 transmits an ACK/NACK (including optionally indicating bi/multicast status) to the gNB-CU-UP 594. At 507-b, the UE 510 transmits an ACK/NACK (including optionally indicating bi/multicast status) to the assisting gNB-DU 595-2, the assisting gNB-DU 595-2 transmits an ACK/NACK (including optionally indicating bi/multicast status) to the gNB-CU-CP 596, and the gNB-CU-CP 596 transmits an ACK/NACK (including optionally indicating bi/multicast status) to the gNB-CU-UP 594. At 507-c, the UE 510 optionally reports multicast status (i.e. one or both received) to the gNB-CU-CP 596. At 508, the gNB-CU-CP 596 and the gNB-CU-UP 594 determine success of the bi/multicast transmissions.

The examples described herein are applicable for 5G and beyond products, such as Airscale and Cloud Radio. The examples described herein may also be applicable to 3GPP standards such as 3GPP TS 38.473 (F1) and TS 38.331 (RRC).

The examples described herein may be implemented in messages and IEs exchanged over F1AP and RRC protocols, including UE capability for L2/L3 bi/multicast control signaling. New TS38.331 6.3.3 UE capability information elements may include a parameter X indicating L2/L3 bi/multicast control signaling support, 2 new bits indicating support for L2 bi/multicast in UL or DL (i.e. 1 bit for UL, 1 for DL)—used at the DU, 2 new bits indicating support for L3 bi/multicast in UL or DL (i.e. 1 bit for UL, 1 for DL)—used at the CU, and optionally, 2 additional new bits indicating support for L2/L3 bi/multicast for both UL/DL (signaling optimization in case the UE supports UL and DL for both L2/L3 at the same time).

TS38.331 V16.5.0 (2021 June) section 5.6.1 UE capability transfer (incorporated by reference) may also be impacted in one of its future releases/versions, for example, including introduction of transfer of UE capability information (e.g. via an UECapabilityInformation IE) including use of an L2/L3 bi/multicast control signaling support/bit towards the serving DU/gNB. Other standardization aspects that may be introduced include duplicate detection of DL bi/multicast signaling, duplicate detection of L3 signaling (TS38.331 6.2.2 RRCReconfiguration message with new RRC IEs), duplicate detection of L2 signaling (TS38.321 5.18 & 6.1.3: Addition of a 1-bit indicator to indicate duplicate). Further standardization aspects that may be introduced include activation and deactivation of bi/multicasting, e.g., a new IE added to TS 38.473, 9.2.1.5: F1 setup response and 9.2.1.10 GNB-CU CONFIGURATION UPDATE to allow the CU to activate/deactivate the feature. Enumerated values ON/OFF may be provisioned for this.

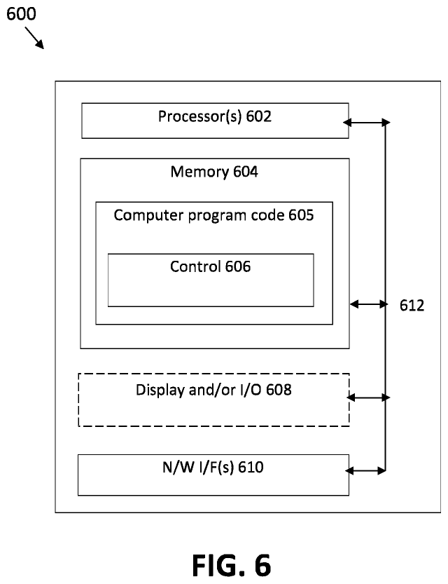

FIG. 6 is an example apparatus 600, which may be implemented in hardware, configured to implement the examples described herein. The apparatus 600 comprises at least one processor 602 (e.g., an FPGA and/or CPU), at least one memory 604 including computer program code 605, wherein at the least one memory 604 and the computer program code 605 are configured to, with at least one processor 602, cause the apparatus 600 to implement circuitry, a process, component, module, or function (collectively control 606) to implement the examples described herein, including L2/L3 control plane robustness for L1/L2 mobility using multi-TRP operation. The memory 604 may be a non-transitory memory, a transitory memory, a volatile memory, or a non-volatile memory.

The apparatus 600 optionally includes a display and/or I/O interface 608 that may be used to display aspects or a status of the methods described herein (e.g., as one of the methods is being performed or at a subsequent time), or to receive input from a user such as with using a keypad. The apparatus 600 includes one or more network (N/W) interfaces (I/F(s)) 610. The N/W I/F(s) 610 may be wired and/or wireless and communicate over the Internet/other network(s) via any communication technique. The N/W I/F(s) 610 may comprise one or more transmitters and one or more receivers. The N/W I/F(s) 610 may comprise standard well-known components such as an amplifier, filter, frequency-converter, (de)modulator, and encoder/decoder circuitries and one or more antennas.

The apparatus 600 to implement the functionality of control 606 may be the UE (110, 410, 510), RAN node 170, network element(s) 190, or any of the other items depicted in FIGS. 1-5 such as the UE, serving gNB-DU, assisting gNB-DU, gNB-CU-CP, or the gNB-CU-UP. Apparatus 600 may be part of a self-organizing/optimizing network (SON) node, such as in a cloud. The apparatus 600 may also be distributed throughout the network 100 including within and between apparatus 600 and any network element (such as a network control element (NCE) 190 and/or the RAN node 170 and/or the UE 110) including the network elements depicted in FIGS. 1-5.

Interface 612 enables data communication between the various items of apparatus 600, as shown in FIG. 6. For example, the interface 612 may be one or more buses such as address, data, or control buses, and may include any interconnection mechanism, such as a series of lines on a motherboard or integrated circuit, fiber optics or other optical communication equipment, and the like. Computer program code 605, including control 606 may comprise object-oriented software configured to pass data/messages between objects within computer program code 605. The apparatus 600 need not comprise each of the features mentioned, or may comprise other features as well.

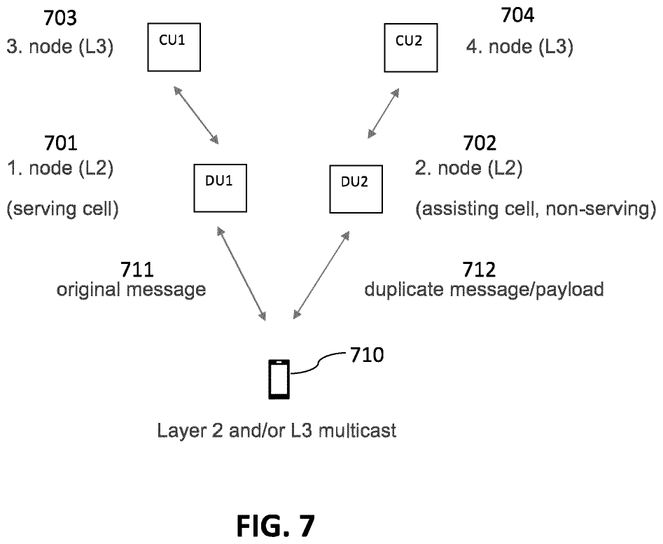

FIG. 7 is a block diagram illustrating L2/L3 signaling, based on the examples described herein. In FIG. 7, the first network node 701 supports a Distribution Unit functionality and/or L2 processing, the third network node 703 provides a Central Unit functionality and/or L3 processing, the second network node 702 provides a Distribution Unit functionality and/or L2 processing, and the fourth network node 704 provides a Central Unit functionality and/or L3 processing.

In FIG. 7, the user equipment 710 includes circuitry configured to store a L2 and/or L3 multicast operation capability, wherein a L2 multicast operation enables the user equipment 710 to receive a first L2 message 711 from the first network node 701, and a second L2 message 712 from the second network node 702, wherein a payload of second L2 message 712 is a duplicate of a payload of the first message 711, and wherein a L3 multicast operation enables the user equipment 710 to receive a third L3 message from the third network node 703, and a fourth L3 message from the fourth network node 704, wherein a payload of fourth L3 message is a duplicate of a payload of third message. The circuitry of the user equipment 710 is configured to transmit the L2 and/or L3 multicast operation capability towards the first 701 or third network node 703, and to receive a control message from the first 701 or third network node 703, wherein the message includes an indication to the user equipment 710 to activate the L2 and/or L3 multicast operation depending on its capability. The circuitry of the user equipment 710 is configured to activate the L2 and/or L3 multicast operation based on the control message.

In FIG. 7, the L3 message may be a Radio Resource Control message and the payload of the L3 message may be a Radio Resource Control payload. The first network node 701 supports a Distribution Unit functionality and/or L2 processing, the third network node 703 provides a Central Unit functionality and/or L3 processing, the second network node 702 provides a Distribution Unit functionality and/or L2 processing, and the fourth network node 704 provides a Central Unit functionality and/or L3 processing. With further reference to FIG. 7, in some examples, the first 701 and the second network node 702 are different, and the third 703 and fourth network node 704 are the same. The user equipment 710 is further configured to, in case of activation of L2 multicast operation, monitor receipt of the first 711 and/or second L2 message 712, and in case of receipt of at least one of both transmit an acknowledgement to at least the first 701 and/or the second network node 702, and in case of activation of L3 multicast operation, monitor receipt of third and/or fourth L3 message, and in case of receipt of at least one of both transmit an acknowledgement to at least the third 703 and/or the fourth network node 704. The control message may further include an indication to the user equipment 710 to enable detection of the second 712 and/or fourth message. The control message further includes an indication to the user equipment 710 to enable detection of the second 712 and/or fourth message by providing the cell ID of the second 702 and/or fourth network node 704.

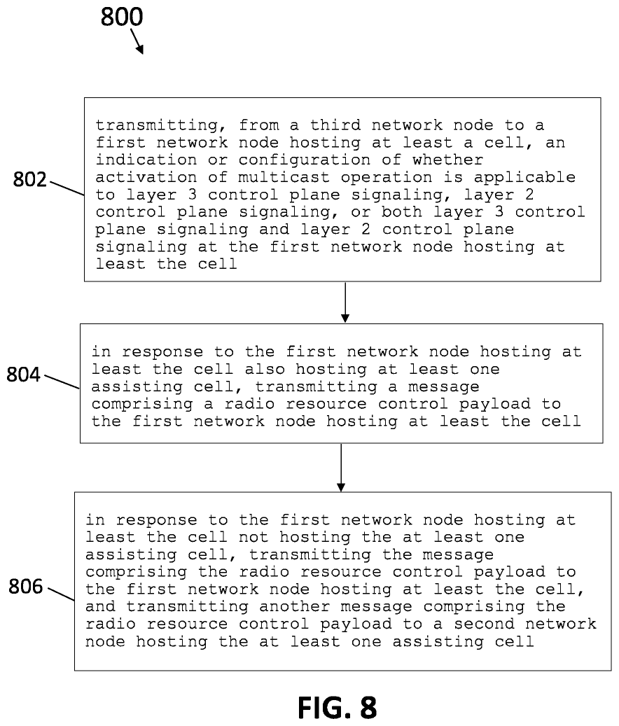

FIG. 8 is an example method 800 to implement the example embodiments described herein. At 802, the method includes transmitting, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell. At 804, the method includes in response to the first network node hosting at least the cell also hosting at least one assisting cell, transmitting a message comprising a radio resource control payload to the first network node hosting at least the cell. At 806, the method includes in response to the first network node hosting at least the cell not hosting the at least one assisting cell, transmitting the message comprising the radio resource control payload to the first network node hosting at least the cell, and transmitting another message comprising the radio resource control payload to a second network node hosting the at least one assisting cell. Method 800 may be performed with a CU-CP apparatus.

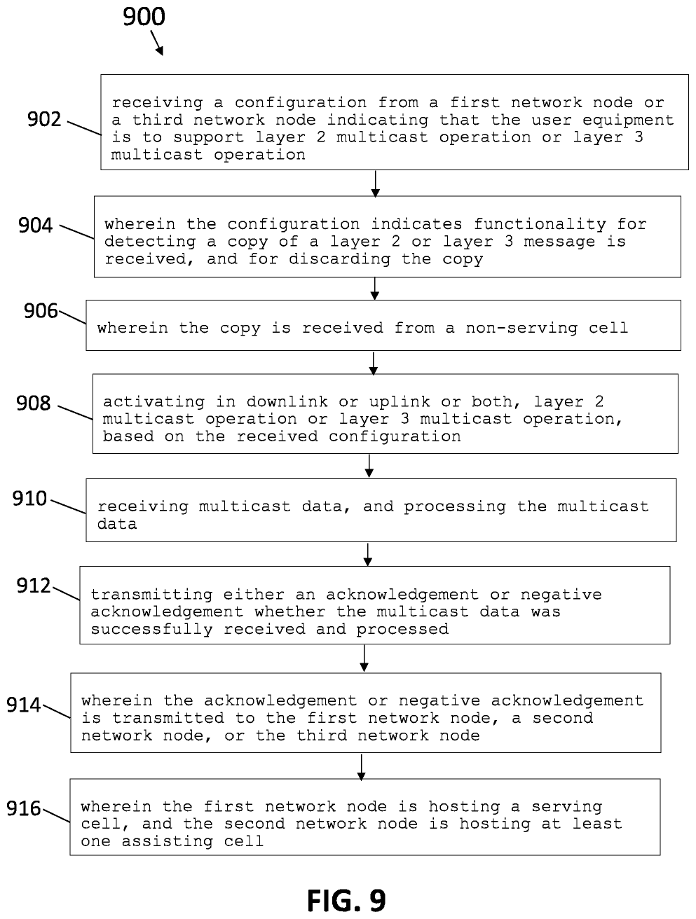

FIG. 9 is an example method 900 to implement the example embodiments described herein. At 902, the method includes receiving a configuration from a first network node or a third network node indicating that the user equipment is to support layer 2 multicast operation or layer 3 multicast operation. At 904, the method includes wherein the configuration indicates functionality for detecting a copy of a layer 2 or layer 3 message is received, and for discarding the copy. At 906, the method includes wherein the copy is received from a non-serving cell. At 908, the method includes activating in downlink or uplink or both, layer 2 multicast operation or layer 3 multicast operation, based on the received configuration. At 910, the method includes receiving multicast data, and processing the multicast data. At 912, the method includes transmitting either an acknowledgement or negative acknowledgement whether the multicast data was successfully received and processed. At 914, the method includes wherein the acknowledgement or negative acknowledgement is transmitted to the first network node, a second network node, or the third network node. At 916, the method includes wherein the first network node is hosting a serving cell, and the second network node is hosting at least one assisting cell. Method 900 may be performed with a user equipment.

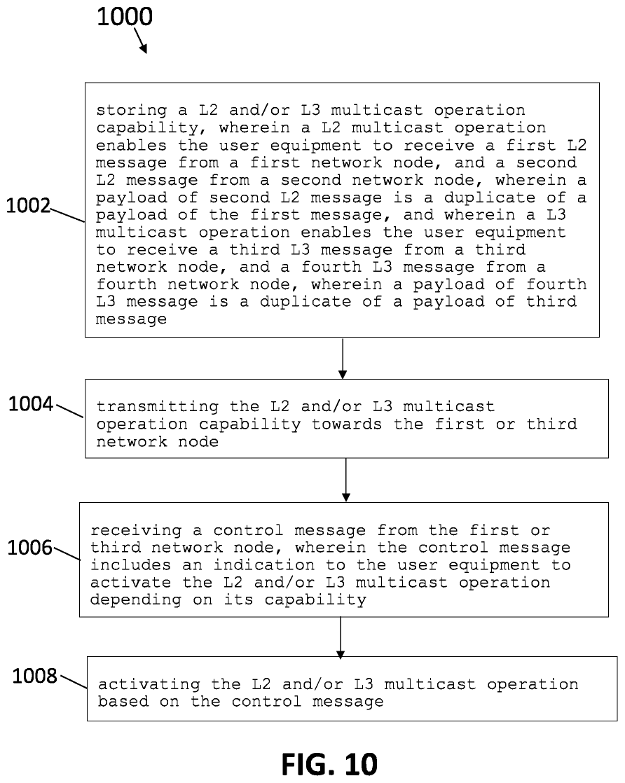

FIG. 10 is an example method 1000 to implement the example embodiments described herein. At 1002, the method includes storing a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message. At 1004, the method includes transmitting the L2 and/or L3 multicast operation capability towards the first or third network node. At 1006, the method includes receiving a control message from the first or third network node, wherein the control message includes an indication to the user equipment to activate the L2 and/or L3 multicast operation depending on its capability. At 1008, the method includes activating the L2 and/or L3 multicast operation based on the control message. Method 1000 may be performed with a user equipment.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The following description may provide further details of alternatives, modifications and variances: A gNB comprises e.g. a node providing NR user plane and control plane protocol terminations towards the UE, and connected via the NG interface to the 5GC, e.g. according to 3GPP TS 38.300 V16.6.0 (2021 June) section 3.2 incorporated by reference.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021 July) section 3.1 incorporated by reference.

Different functional splits between the central and distributed unit are possible, e.g. called options:

### Option 1 (1A-Like Split)

The function split in this option is similar as 1A architecture in DC. RRC is in the central unit. PDCP, RLC, MAC, physical layer and RF are in the distributed unit.

### Option 2 (3C-Like Split)

The function split in this option is similar as 3C architecture in DC. RRC, PDCP are in the central unit. RLC, MAC, physical layer and RF are in the distributed unit.

### Option 3 (Intra RLC Split)

Low RLC (partial function of RLC), MAC, physical layer and RF are in the distributed unit. PDCP and high RLC (the other partial function of RLC) are in the central unit.

### Option 4 (RLC-MAC Split)

MAC, physical layer and RF are in the distributed unit. PDCP and RLC are in the central unit.

Or else, e.g. according to 3GPP TR 38.801 V14.0.0 (2017 March) section 11 incorporated by reference.

A gNB supports different protocol layers, e.g.

Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and segm. to segmentation;
Control channels (BCCH, PCCH).

Layer 3 (L3) includes e.g. Radio Resource Control (RRC), e.g. according to 3GPP TS 38.300 V16.6.0 (2021 July) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or processing of CU and/or DU related functionality and/or features, and/or at least one protocol (sub-)layer of a RAN (Radio Access Network), e.g. layer 2 and/or layer 3.

The gNB CU and gNB DU parts may e.g. be co-located or physically separated. gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021 July) sections 42.1 and 4.4, incorporated by reference).

A UE is e.g. either in RRC_CONNECTED state or in RRC_INACTIVE state when an RRC connection has been established.

In RRC_CONNECTED state a UE may:
store the AS context;
transfer of unicast data to/from UE;
Monitor control channels associated with the shared data channel to determine if data is scheduled for it;
provide channel quality and feedback information;
perform neighboring cell measurements and measurement reporting;

The RRC protocol includes e.g. the following main functions:
RRC connection control:
Measurement configuration and reporting:
Establishment/modification/release of measurement configuration (e.g. intra-frequency, inter-frequency and inter-RAT measurements);
Setup and release of measurement gaps;
Measurement reporting.

Multicast operation (also including bi-casting operation (original+copy/duplicate)):

In downlink: transmitting a message from at least two different cells to a single user equipment (UE), e.g. transmitting a message, e.g. RRC message or RRC PDU (Packet Data Unit), from a first, serving cell to a UE and transmitting a copy or duplicate of the message or at least its payload, e.g. RRC payload or RRC SDU (Service Data Unit), from an assisting cell to the UE. This way the UE receives the “same” message via at least two different radio links, e.g. at least twice. If one radio link is disturbed, the message is received at least once. The message and its duplicate are preferably transmitted simultaneously or shortly one after the other, e.g. within milliseconds. The message may be a control plane signaling message, e.g. RRC message comprising RRC payload, or a user plane message comprising data. A message may include a header and payload, and potentially a footer.

In uplink: transmitting a message from a single user equipment (UE) to at least two different cells, e.g. transmitting a message, e.g. Acknowledgement (ACK) message, from the UE to a first, serving cell and/or transmitting a copy or duplicate of the message or at least its content from the UE to an assisting cell. The message and its duplicate are preferably transmitted simultaneously or shortly one after the other, e.g. within milliseconds. The message may be a control plane signaling message, e.g. ACK message, or a user plane message comprising data.

With respect to the description herein, multicast may be called duplicate operation, as multicast is typically point-to-multipoint, while as described herein there are two unicast messages travelling via different radio links, one original and a copy/duplicate thereof (at least payload), however as used herein this concept is also referred to as multicast.

The following examples 1-100 are provided herein among the disclosed examples.

Example 1: An apparatus includes at least one processor; and at least one memory including computer program code; wherein the at least one memory and the computer program code are configured to, with the at least one processor, cause the apparatus at least to: receive from a second network node, with a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; transmit to a user equipment, based on the indication, a first message comprising a radio resource control payload scheduled using resources of a serving cell, and a second message comprising a radio resource control payload scheduled using resources of at least one assisting cell, in response to the indication conveying that the activation of multicast operation is applicable to layer 3 control plane signaling; wherein the first message comprising the radio resource control payload and the second message comprising the radio resource control payload are generated by and received from the second network node; wherein the second message comprising the radio resource control payload is a copy of the first message comprising the radio resource control payload; and transmit to the user equipment, based on the configuration, a first medium access control element message scheduled using resources of the serving cell, and a second medium access control element message scheduled using resources of the at least one assisting cell, in response to the configuration conveying that the activation of multicast operation is applicable to layer 2 control plane signaling; wherein the first medium access control element message and the second medium access control element message are generated at the first network node; wherein the second medium access control element message is a copy of the first medium access control element message.

Example 2: The apparatus of example 1, wherein the at least one memory and the computer program code are further configured to, with the at least one processor, cause the apparatus at least to: transmit an indication of support of multicast operation to a control plane entity of the second network node.

Example 3: The apparatus of any one of examples 1 to 2, wherein the indication or configuration of whether activation of multicast operation is applicable, is received along with a selected radio resource control payload scheduled using resources of the serving cell, and a selected radio resource control payload scheduled using resources of the at least one assisting cell.

Example 4: The apparatus of any one of examples 1 to 3, wherein the at least one memory and the computer program code are further configured to, with the at least one processor, cause the apparatus at least to: determine whether to execute a layer 1 and layer 2 centric inter cell change, prior to transmitting to the user equipment the first medium access control element message scheduled using resources of the serving cell and the second medium access control element message scheduled using resources of the at least one assisting cell.

Example 5: The apparatus of any one of examples 1 to 4, wherein the at least one memory and the computer program code are further configured to, with the at least one processor, cause the apparatus at least to: receive user plane multicast data from a user plane entity of the second network node, and transmit the user plane multicast data to the user equipment.

Example 6: The apparatus of any one of examples 1 to 5, wherein the at least one memory and the computer program code are further configured to, with the at least one processor, cause the apparatus at least to: receive control plane multicast data from the second network node, and transmit the control plane multicast data to the user equipment.

Example 7: The apparatus of any one of examples 1 to 6, wherein the at least one memory and the computer program code are further configured to, with the at least one processor, cause the apparatus at least to: receive feedback, an acknowledgement or negative acknowledgement from the user equipment that multicast data has been received and/or processed; and transmit an indication whether the user equipment has received and/or processed the multicast data to a control plane entity of the second network node.

Example 8: The apparatus of any one of examples 1 to 7, wherein the configuration and indication are transmitted over an interface between the first network node and the second network node.

Example 9: The apparatus of any one of examples 1 to 8, wherein the at least one memory and the computer program code are further configured to, with the at least one processor, cause the apparatus at least to: transmit, to the user equipment, additional information along with the radio resource control payload scheduled using resources of the serving cell, and additional information along with the radio resource control payload scheduled using resources of the at least one assisting cell; and transmit, to the user equipment, additional information in the medium access control element message scheduled using resources of the serving cell, and additional information in the medium access control element message scheduled using resources of the at least one assisting cell; wherein the additional information enables the user equipment to perform duplicate detection and discarding functionality.

Example 10: The apparatus of any one of examples 1 to 9, wherein the at least one memory and the computer program code are further configured to, with the at least one processor, cause the apparatus at least to: determine a number of copies of a message to send to the user equipment.

Example 11: The apparatus of any one of examples 1 to 10, wherein the at least one memory and the computer program code are further configured to, with the at least one processor, cause the apparatus at least to: detect duplicate copies of multiple received uplink messages from the user equipment; discard at least one of the multiple received messages; and transmit a single copy of the multiple received messages to the second network node.

Example 12: The apparatus of any one of examples 1 to 11, wherein the indication or configuration of whether activation of multicast operation is applicable is associated with a set of user equipments for which the multicast operation is to be applied.

Example 13: The apparatus of any one of examples 1 to 12, wherein the indication or configuration of whether activation of multicast operation is applicable is not associated with a set of user equipments and is generally associated with any user equipment that supports multicast operation.

Example 14: The apparatus of any one of examples 1 to 13, wherein the first medium access control element message scheduled using resources of the serving cell comprises at least a layer 1 centric inter cell mobility related handover command, and the second medium access control element message scheduled using resources of the at least one assisting cell comprises at least a layer 1 centric inter cell mobility related handover command.

Example 15: The apparatus of any one of examples 1 to 14, wherein the indication of whether activation of multicast operation is applicable is transmitted as an on or off flag, and the configuration of whether activation of multicast operation is applicable is transmitted as a setup message over an interface between the first network node and the second network node.

Example 16: The apparatus of any one of examples 1 to 15, wherein the at least one memory and the computer program code are further configured to, with the at least one processor, cause the apparatus at least to: transmit to the second network node a first notification indicating that the first message comprising the radio resource control payload scheduled using resources of the serving cell was transmitted successfully; transmit to the second network node a second notification indicating that the second message comprising the radio resource control payload scheduled using resources of the at least one assisting cell was transmitted successfully; transmit to the second network node a third notification indicating that the first medium access control element message scheduled using resources of the serving cell was transmitted successfully; and transmit to the second network node a fourth notification indicating that the second medium access control element message scheduled using resources of the at least one assisting cell was transmitted successfully; wherein a successful transmission is determined based on feedback received from the user equipment; and wherein the first, second, third, and fourth notifications are configured to be used with the second network node to learn at least one criterion to activate multicasting; wherein the at least one criterion includes at least one of specific message type, type of user equipments, or characteristics of cells.

Example 17: The apparatus of any one of examples 1 to 16, wherein the at least one memory and the computer program code are further configured to, with the at least one processor, cause the apparatus at least to: transmit, from the first network node hosting at least the cell over an interface between network nodes, layer 2 control signaling to a third network node hosting the at least one assisting cell, to actuate multicasting using a radio link associated with the third network node hosting the at least one assisting cell.

Example 18: The apparatus of any one of examples 1 to 17, wherein the at least one memory and the computer program code are further configured to, with the at least one processor, cause the apparatus at least to: transmit an original message from the first network node hosting at least the cell; and receive an acknowledgement from the user equipment that the original message was received.

Example 19: The apparatus of example 18, wherein the at least one memory and the computer program code are further configured to, with the at least one processor, cause the apparatus at least to: receive an indication from the user equipment that that a duplicate message sent from a third network node hosting the at least one assisting cell was received before the original message; or receive an indication from the user equipment that the original message was not received.

Example 20: An example apparatus includes at least one processor; and at least one memory including computer program code; wherein the at least one memory and the computer program code are configured to, with the at least one processor, cause the apparatus at least to: receive from a second network node, with a first network node hosting at least one assisting cell, a message comprising a radio resource control payload; transmit, from the first network node hosting the at least one assisting cell, the message comprising the radio resource control payload to a user equipment; receive user plane multicast data and control plane multicast data from the second network node; transmit the user plane multicast data to the user equipment; transmit the control plane multicast data to the user equipment, when multicasting is configured; and receive an acknowledgement from the user equipment that the multicast data was successfully received and/or processed.

Example 21: The apparatus of example 20, wherein the message comprising the radio resource control payload indicates that multicast operation is applicable to layer 3 signaling.

Example 22: The apparatus of any one of examples 20 to 21, wherein the message comprising the radio resource control payload is received over an interface between the first network node hosting the at least one assisting cell and the second network node.

Example 23: The apparatus of any one of examples 20 to 22, wherein the at least one memory and the computer program code are further configured to, with the at least one processor, cause the apparatus at least to: transmit, from the first network node hosting the at least one assisting cell, additional information along with the radio resource control payload to the user equipment; wherein the additional information enables the user equipment to perform duplicate detection and discarding functionality.

Example 24: The apparatus of any one of examples 20 to 23, wherein the at least one memory and the computer program code are further configured to, with the at least one processor, cause the apparatus at least to: receive feedback, an acknowledgement or negative acknowledgement from the user equipment regarding the receipt or processing of multicast data; and transmit the acknowledgement or negative acknowledgement to the second network node.

Example 25: The apparatus of any one of examples 20 to 24, wherein the at least one memory and the computer program code are further configured to, with the at least one processor, cause the apparatus at least to: receive, from a third network node hosting a serving cell over an interface between network nodes, layer 2 control signaling with the first network node hosting the at least one assisting cell, to actuate multicasting using a radio link associated with the first network node hosting the at least one assisting cell.

Example 26: The apparatus of any one of examples 20 to 25, wherein the message comprising the radio resource control payload transmitted from the first network node hosting the at least one assisting cell to the user equipment relates to layer 3 control signaling.

Example 27: The apparatus of any one of examples 20 to 26, wherein the at least one memory and the computer program code are further configured to, with the at least one processor, cause the apparatus at least to: transmit a duplicate message from the first network node hosting the at least one assisting cell to the user equipment; and receive an acknowledgement from the user equipment that the duplicate message was received.

Example 28: The apparatus of example 27, wherein the at least one memory and the computer program code are further configured to, with the at least one processor, cause the apparatus at least to: receive an indication from the user equipment that the duplicate message was received before an original message transmitted from a third network node hosting a serving cell; or receive an indication from the user equipment that the original message was not received.

Example 29: An example apparatus includes at least one processor; and at least one memory including computer program code; wherein the at least one memory and the computer program code are configured to, with the at least one processor, cause the apparatus at least to: transmit, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; in response to the first network node hosting at least the cell also hosting at least one assisting cell, transmit a message comprising a radio resource control payload to the first network node hosting at least the cell; and in response to the first network node hosting at least the cell not hosting the at least one assisting cell, transmit the message comprising the radio resource control payload to the first network node hosting at least the cell, and transmit another message comprising the radio resource control payload to a second network node hosting the at least one assisting cell.

Example 30: The apparatus of example 29, wherein the at least one memory and the computer program code are further configured to, with the at least one processor, cause the apparatus at least to: determine a number of copies of a message to send to a user equipment.

Example 31: The apparatus of any one of examples 29 to 30, wherein the at least one memory and the computer program code are further configured to, with the at least one processor, cause the apparatus at least to: determine that the multicast operation is applicable to layer 3 signaling.

Example 32: The apparatus of any one of examples 29 to 31, wherein the configuration and indication are transmitted over an interface between the third network node and the first network node hosting at least the cell.

Example 33: The apparatus of any one of examples 29 to 32, wherein the indication or configuration of whether activation of multicast operation is applicable is associated with a set of user equipments for which the multicast operation is to be applied.

Example 34: The apparatus of any one of examples 29 to 33, wherein the indication or configuration of whether activation of multicast operation is applicable is not associated with a set of user equipments and is generally associated with any user equipment that supports multicast operation.

Example 35: The apparatus of any one of examples 29 to 34, wherein the indication of whether activation of multicast operation is applicable is transmitted as an on or off flag, and the configuration of whether activation of multicast operation is applicable is transmitted as a setup message over an interface between the third network node and the first network node hosting at least the cell.

Example 36: The apparatus of any one of examples 29 to 35, wherein the at least one memory and the computer program code are further configured to, with the at least one processor, cause the apparatus at least to: receive an indication of support of multicast operation from the first network node hosting at least the cell.

Example 37: The apparatus of any one of examples 29 to 36, wherein the at least one memory and the computer program code are further configured to, with the at least one processor, cause the apparatus at least to: transmit a copy of control plane multicast data of a serving cell to the second network node hosting the at least one assisting cell.

Example 38: The apparatus of any one of examples 29 to 37, wherein the at least one memory and the computer program code are further configured to, with the at least one processor, cause the apparatus at least to: receive feedback, an acknowledgement or negative acknowledgement regarding transmission, receipt, or processing of multicast data from the first network node hosting at least the cell, the second network node hosting the at least one assisting cell, and/or the user equipment; and learn, based on an artificial intelligence or machine learning method, at least one criterion to activate multicasting using the acknowledgement or negative acknowledgement; wherein the at least one criterion includes at least one of specific message type, type of user equipments, or characteristics of cells.

Example 39: The apparatus of any one of examples 29 to 38, wherein the at least one memory and the computer program code are further configured to, with the at least one processor, cause the apparatus at least to: receive a first notification that the radio resource control payload was transmitted to the user equipment from the first network node hosting at least the cell; and receive a second notification that the radio resource control payload was transmitted to the user equipment from the second network node hosting the at least one assisting cell; and learn, based on an artificial intelligence or machine learning method, when to activate multicasting using the first notification and the second notification.

Example 40: The apparatus of any one of examples 29 to 39, wherein the at least one memory and the computer program code are further configured to, with the at least one processor, cause the apparatus at least to: determine success of at least one multicast transmission.

Example 41: The apparatus of any one of examples 29 to 40, wherein: the message comprising the radio resource control payload transmitted to the first network node hosting at least the cell indicates that multicast operation is applicable to layer 3 signaling; and the another message comprising the radio resource control payload transmitted to the second network node hosting the at least one assisting cell indicates that multicast operation is applicable to layer 3 signaling.

Example 42: The apparatus of any one of examples 29 to 41, wherein the at least one memory and the computer program code are further configured to, with the at least one processor, cause the apparatus at least to: detect duplicate copies of multiple received messages; and discard at least one of the multiple received messages.

Example 43: An example apparatus includes at least one processor; and at least one memory including computer program code; wherein the at least one memory and the computer program code are configured to, with the at least one processor, cause the apparatus at least to: receive, from a control plane entity of a third network node, an indication of setup for user plane multicast operation; transmit user plane multicast data to a first network node hosting a serving cell; transmit the user plane multicast data to a second network node hosting at least one assisting cell; and receive an acknowledgement from the first network node hosting the serving cell, the second network node hosting the least one assisting cell, or the control plane entity of the third network node whether the user plane multicast data has been successfully received and/or processed.

Example 44: The apparatus of example 43, wherein the at least one memory and the computer program code are further configured to, with the at least one processor, cause the apparatus at least to: determine success of at least one multicast transmission or multicast transmission.

Example 45: An example user equipment includes at least one processor; and at least one memory including computer program code; wherein the at least one memory and the computer program code are configured to, with the at least one processor, cause the user equipment at least to: receive a configuration from a first network node or a third network node indicating that the user equipment is to support layer 2 multicast operation or layer 3 multicast operation; wherein the configuration indicates functionality for detecting a copy of a layer 2 or layer 3 message is received, and for discarding the copy; wherein the copy is received from a non-serving cell; activate in downlink or uplink or both, layer 2 multicast operation or layer 3 multicast operation, based on the received configuration; receive multicast data, and process the multicast data; and transmit either an acknowledgement or negative acknowledgement whether the multicast data was successfully received and processed; wherein the acknowledgement or negative acknowledgement is transmitted to the first network node, a second network node, or the third network node; wherein the first network node is hosting a serving cell, and the second network node is hosting at least one assisting cell.

Example 46: The user equipment of example 45, wherein the configuration is received with at least one of: a radio resource control transaction identifier; a medium access control element; a medium access control logical channel identifier; or at least one packet header element.

Example 47: The user equipment of any one of examples 45 to 46, wherein the at least one memory and the computer program code are further configured to, with the at least one processor, cause the user equipment at least to: receive, from the first network node hosting the serving cell, a medium access control element handover message associated with a serving cell related to layer 2 signaling, or a radio resource control message associated with the serving cell related to layer 3 signaling.

Example 48: The user equipment of any one of examples 45 to 47, wherein the at least one memory and the computer program code are further configured to, with the at least one processor, cause the user equipment at least to: receive, from the first network node hosting the serving cell, a medium access control element handover message associated with the at least one assisting cell related to layer 2 signaling, or a radio resource control message associated with the at least one assisting cell related to layer 3 signaling.

Example 49: The user equipment of any one of examples 45 to 48, wherein the at least one memory and the computer program code are further configured to, with the at least one processor, cause the user equipment at least to: receive, from the second network node hosting the at least one assisting cell, a radio resource control message associated with the at least one assisting cell related to layer 3 signaling.

Example 50: The user equipment of any one of examples 45 to 49, wherein the at least one memory and the computer program code are further configured to, with the at least one processor, cause the user equipment at least to: receive an original message from the first network node hosting the serving cell, and subsequently receive a duplicate message from the second network node hosting the at least one assisting cell; process the original message, and send a first acknowledgement to the first network node hosting the serving cell; and discard the duplicate message, and send a second acknowledgement to the second network node hosting the at least one assisting cell.

Example 51: The user equipment of any one of examples 45 to 50, wherein the at least one memory and the computer program code are further configured to, with the at least one processor, cause the user equipment at least to: receive a duplicate message from the second network node hosting the at least one assisting cell, and subsequently receive an original message from the first network node hosting the serving cell; process the duplicate message, and send a first acknowledgement to the second network node hosting the at least one assisting cell; and discard the original message, and send a second acknowledgement to the first network node hosting the serving cell.

Example 52: The user equipment of example 51, wherein the at least one memory and the computer program code are further configured to, with the at least one processor, cause the user equipment at least to: indicate to both the second network node hosting the at least one assisting cell and the first network node hosting the serving cell that the duplicate message was received before the original message.

Example 53: The user equipment of any one of examples 45 to 52, wherein the at least one memory and the computer program code are further configured to, with the at least one processor, cause the user equipment at least to: receive a duplicate message from the second network node hosting the at least one assisting cell, and not receive an original message from the first network node hosting the serving cell; and process the duplicate message, and send an acknowledgement to the first network node hosting the at least one assisting cell that the duplicate message was processed.

Example 54: The user equipment of example 53, wherein the at least one memory and the computer program code are further configured to, with the at least one processor, cause the user equipment at least to: indicate to both the second network node hosting the at least one assisting cell and the first network node hosting the serving cell that the original message was not received.

Example 55: The user equipment of any one of examples 45 to 54, wherein the at least one memory and the computer program code are further configured to, with the at least one processor, cause the user equipment at least to: transmit an acknowledgement report to the third network node, the acknowledgement report configured to be used with at least one artificial intelligence or machine learning algorithm to determine when to enable multicasting or determine whether a set of one or more network nodes nodes are eligible for multicasting.

Example 56: The user equipment of any one of examples 45 to 55, wherein the configuration indicates a data direction for the user equipment as being uplink, downlink, or both uplink and downlink.

Example 57: The user equipment of any one of examples 45 to 56, wherein the at least one memory and the computer program code are further configured to, with the at least one processor, cause the user equipment at least to: receive medium access control information indicating whether signaling received is duplicate signaling.

Example 58: The user equipment of any one of examples 45 to 57, wherein the acknowledgement or negative acknowledgement of whether the multicast data was successfully received and processed is transmitted either to: at least one of the first network node or the second network node when the multicast data was received with layer 2 signaling; or the third network node when the multicast data was received with layer 3 signaling.

Example 59: An example method includes transmitting, to a first network node, an indication or configuration of whether activation of multicast operation is applicable to layer 3 control plane signaling, layer 2 control plane signaling, or both layer 3 control plane signaling and layer 2 control plane signaling at the first network node; transmitting to a user equipment, based on the indication, a first message comprising a radio resource control payload scheduled using resources of a serving cell, and a second message comprising a radio resource control payload scheduled using resources of at least one assisting cell, in response to the indication conveying that the activation of multicast operation is applicable to layer 3 control plane signaling; wherein the first message comprising the radio resource control payload and the second message comprising the radio resource control payload are generated by an received from a second network node; wherein the second message comprising the radio resource control payload is a copy of the first message comprising the radio resource control payload; and transmitting to the user equipment, based on the configuration, a first medium access control element message scheduled using resources of the serving cell, and a second medium access control element message scheduled using resources of the at least one assisting cell, in response to the configuration conveying that the activation of multicast operation is applicable to layer 2 control plane signaling; wherein the first medium access control element message and the second medium access control element message are generated at the distributed node; wherein the second medium access control element message is a copy of the first medium access control element message.

Example 60: The method of example 59, wherein the configuration and indication are transmitted over an interface between the first network node and the second network node.

Example 61: The method of any one of examples 59 to 60, further comprising: determining, with the first network node, whether to execute a layer 1 and layer 2 centric inter cell change, prior to transmitting to the user equipment the first medium access control element message scheduled using resources of the serving cell and the second medium access control element message scheduled using resources of the at least one assisting cell.

Example 62: The method of any one of examples 59 to 61, further comprising: transmitting, to the user equipment, additional information along with the radio resource control payload scheduled using resources of the serving cell, and at least an additional message comprising the radio resource control payload scheduled using resources of the at least one assisting cell; and transmitting to the user equipment, at least an additional medium access control element message scheduled using resources of the serving cell, and at least an additional medium access control element message scheduled using resources of the at least one assisting cell.

Example 63: The method of any one of examples 59 to 62, wherein the second network node determines a number of copies of a message to send to the user equipment.

Example 64: The method of any one of examples 59 to 63, wherein the first network node determines a number of copies of a message to send to the user equipment.

Example 65: The method of any one of examples 59 to 64, further comprising: detecting, with the first network node, duplicate copies of multiple received uplink messages from the user equipment; discarding at least one of the multiple received messages; and transmitting a single copy of the multiple received messages to the second network node.

Example 66: The method of any one of examples 59 to 65, wherein the indication or configuration of whether activation of multicast operation is applicable is associated with a set of user equipments for which the multicast operation is to be applied.

Example 67: The method of any one of examples 59 to 66, wherein the indication or configuration of whether activation of multicast operation is applicable is not associated with a set of user equipments and is generally associated with any user equipment that supports multicast operation.

Example 68: The method of any one of examples 59 to 67, wherein the first medium access control element message scheduled using resources of the serving cell comprises at least a layer 1 centric inter cell mobility related handover command, and the second medium access control element message scheduled using resources of the at least one assisting cell comprises at least a layer 1 centric inter cell mobility related handover command.

Example 69: The method of any one of examples 59 to 68, wherein the indication of whether activation of multicast operation is applicable is transmitted as an on or off flag, and the configuration of whether activation of multicast operation is applicable is transmitted as a setup message over an interface between the first network node and the second network node.

Example 70: The method of any one of examples 59 to 69, further comprising: transmitting to the second network node a first notification indicating that the first message comprising the radio resource control payload scheduled using resources of the serving cell was transmitted successfully; transmitting to the second network node a second notification indicating that the second message comprising the radio resource control payload scheduled using resources of the at least one assisting cell was transmitted successfully; transmitting to the second network node a third notification indicating that the first medium access control element message scheduled using resources of the serving cell was transmitted successfully; and transmitting to the second network node a fourth notification indicating that the second medium access control element message scheduled using resources of the at least one assisting cell was transmitted successfully; wherein a successful transmission is determined based on feedback received from the user equipment; and wherein the first, second, third, and fourth notifications are configured to be used with the second network node to learn at least one criterion to activate multicasting; wherein the at least one criterion includes at least one of specific message type, type of user equipments, or characteristics of cells.

Example 71: The method of any one of examples 59 to 70, further comprising: transmitting, from the first network node, an indication of support of multicast operation to the second network node.

Example 72: An example method includes transmitting, from a third network node to a first network node hosting at least a cell, a first indication that multicast operation is applicable to layer 3 signaling, the first indication comprising a radio resource control payload; transmitting, from the first network node hosting at least the cell, a first message comprising the radio resource control payload to a user equipment; transmitting, from the third network node to a second network node hosting at least one assisting cell, a second indication that multicast operation is applicable to layer 3 signaling, the second indication comprising the radio resource control payload; and transmitting, from the second network node hosting the at least one assisting cell, a second message comprising the radio resource control payload to the user equipment; wherein the first message comprising the radio resource control payload and the second message comprising the radio resource control payload are generated by and received from the third network node; wherein the second message comprising the radio resource control payload is a copy of the first message comprising the radio resource control payload.

Example 73: The method of example 72, wherein: the first indication is transmitted over an interface between the first network node hosting at least the cell and the third network node; and the second indication is transmitted over an interface between the second network node hosting the at least one assisting cell and the third network node.

Example 74: The method of any one of examples 72 to 73, further comprising: determining, using the third network node, that the multicast operation is applicable to layer 3 signaling.

Example 75: The method of any one of examples 72 to 74, further comprising: transmitting, from the first network node hosting at least the cell, additional information along with the radio resource control payload to the user equipment; and transmitting, from the second network node hosting the at least one assisting cell, additional information along with the radio resource control payload to the user equipment; wherein the additional information enables the user equipment to perform duplicate detection and discarding functionality.

Example 76: The method of any one of examples 72 to 75, wherein the third network node determines a number of copies of a message to send to the user equipment.

Example 77: The method of any one of examples 72 to 76, wherein the first network node hosting at least the cell determines a number of copies of a message to send to the user equipment.

Example 78: The method of any one of examples 72 to 77, further comprising: detecting, with the third network node, duplicate copies of multiple received messages; and discarding at least one of the multiple received messages.

Example 79: The method of any one of examples 72 to 78, further comprising: transmitting, from the first network node hosting at least the cell over an interface between network nodes, layer 2 control signaling to the second network node hosting the at least one assisting cell, to actuate multicasting using a radio link associated with the second network node hosting the at least one assisting cell.

Example 80: The method of any one of examples 72 to 79, further comprising: transmitting a first notification to the third network node that the first message comprising the radio resource control payload was transmitted to the user equipment from the first network node hosting at least the cell; and transmitting a second notification to the third network node that the second message comprising the radio resource control payload was transmitted to the user equipment from the second network node hosting the at least one assisting cell; wherein the first and second notifications are configured to be used with the third network node to learn at least one criterion to activate multicasting; wherein the at least one criterion includes at least one of specific message type, type of user equipments, or characteristics of cells.

Example 81: The method of any one of examples 72 to 80, further comprising: transmitting, from the first network node hosting at least the cell, an indication of support of multicast operation to the logical node.

Example 82: The method of any one of examples 59 to 71, wherein the first network node is a distributed node hosting the serving cell, and wherein the first network node hosting the serving cell, and any of a third network node hosting the at least one assisting cell, a control plane entity of the second network node, or user plane entity of the second network are part of a common transmission and reception point device or are part of different transmission and reception point devices.

Example 83: The method of any one of examples 72 to 81, wherein the first network node hosting at least the cell, and any of the second network node hosting the at least one assisting cell, a control plane entity of the third network node, or a user plane entity of the third network node are part of a common transmission and reception point device or are part of different transmission and reception point devices.

Example 84: An example user equipment includes at least one processor; and at least one memory including computer program code; wherein the at least one memory and the computer program code are configured to, with the at least one processor, cause the user equipment at least to: store a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message, transmit the L2 and/or L3 multicast operation capability towards the first or third network node, receive a control message from the first or third network node, wherein the control message includes an indication to the user equipment to activate the L2 and/or L3 multicast operation depending on its capability, and activate the L2 and/or L3 multicast operation based on the control message.

Example 85: A user equipment according to example 84, wherein the L3 message is a Radio Resource Control message and the payload of the L3 message is a Radio Resource Control payload.

Example 86: A user equipment according to any one of examples 84 to 85, wherein the first network node provides a serving cell towards the user equipment, the third network node controls the first network node, the second network node provides an assisting cell to the user equipment, and the fourth network node controls the second network node.

Example 87: A user equipment according to any one of examples 84 to 86, wherein the first network node supports a Distribution Unit functionality and/or L2 processing, the third network node provides a Central Unit functionality and/or L3 processing, the second network node provides a Distribution Unit functionality and/or L2 processing, and the fourth network node provides a Central Unit functionality and/or L3 processing.

Example 88: A user equipment according to any one of examples 84 to 87, wherein the first and the second network node are different, and wherein the third and fourth network node are the same.

Example 89: A user equipment according to any one of examples 84 to 88, wherein the user equipment is further configured to: in case of activation of L2 multicast operation, monitor receipt of the first and/or second L2 message, and in case of receipt of at least one of both transmit an acknowledgement to at least the first and/or the second network node, and in case of activation of L3 multicast operation, monitor receipt of the third and/or fourth L3 message, and in case of receipt of at least one of both transmit an acknowledgement to at least the third and/or the fourth network node.

Example 90: A user equipment according to any one of examples 84 to 89, wherein the control message further includes an indication to the user equipment to enable detection of the second and/or fourth message.

Example 91: A user equipment according to any one of examples 84 to 90, wherein the control message further includes an indication to the user equipment to enable detection of the second and/or fourth message by providing the cell ID of the second and/or fourth network node.

Example 92: An example method includes transmitting, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; in response to the first network node hosting at least the cell also hosting at least one assisting cell, transmitting a message comprising a radio resource control payload to the first network node hosting at least the cell; and in response to the first network node hosting at least the cell not hosting the at least one assisting cell, transmitting the message comprising the radio resource control payload to the first network node hosting at least the cell, and transmitting another message comprising the radio resource control payload to a second network node hosting the at least one assisting cell.

Example 93: An example method includes receiving a configuration from a first network node or a third network node indicating that the user equipment is to support layer 2 multicast operation or layer 3 multicast operation; wherein the configuration indicates functionality for detecting a copy of a layer 2 or layer 3 message is received, and for discarding the copy; wherein the copy is received from a non-serving cell; activating in downlink or uplink or both, layer 2 multicast operation or layer 3 multicast operation, based on the received configuration; receiving multicast data, and processing the multicast data; and transmitting either an acknowledgement or negative acknowledgement whether the multicast data was successfully received and processed; wherein the acknowledgement or negative acknowledgement is transmitted to the first network node, a second network node, or the third network node; wherein the first network node is hosting a serving cell, and the second network node is hosting at least one assisting cell.

Example 94: An example method includes storing a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message, transmitting the L2 and/or L3 multicast operation capability towards the first or third network node, receiving a control message from the first or third network node, wherein the control message includes an indication to the user equipment to activate the L2 and/or L3 multicast operation depending on its capability, and activating the L2 and/or L3 multicast operation based on the control message.

Example 95: An example non-transitory program storage device readable by a machine, tangibly embodying a program of instructions executable with the machine for performing operations is provided, the operations comprising: transmitting, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; in response to the first network node hosting at least the cell also hosting at least one assisting cell, transmitting a message comprising a radio resource control payload to the first network node hosting at least the cell; and in response to the first network node hosting at least the cell not hosting the at least one assisting cell, transmitting the message comprising the radio resource control payload to the first network node hosting at least the cell, and transmitting another message comprising the radio resource control payload to a second network node hosting the at least one assisting cell.

Example 96: An example non-transitory program storage device readable by a machine, tangibly embodying a program of instructions executable with the machine for performing operations is provided, the operations comprising: receiving a configuration from a first network node or a third network node indicating that the user equipment is to support layer 2 multicast operation or layer 3 multicast operation; wherein the configuration indicates functionality for detecting a copy of a layer 2 or layer 3 message is received, and for discarding the copy; wherein the copy is received from a non-serving cell; activating in downlink or uplink or both, layer 2 multicast operation or layer 3 multicast operation, based on the received configuration; receiving multicast data, and processing the multicast data; and transmitting either an acknowledgement or negative acknowledgement whether the multicast data was successfully received and processed; wherein the acknowledgement or negative acknowledgement is transmitted to the first network node, a second network node, or the third network node; wherein the first network node is hosting a serving cell, and the second network node is hosting at least one assisting cell.

Example 97: An example non-transitory program storage device readable by a machine, tangibly embodying a program of instructions executable with the machine for performing operations is provided, the operations comprising: storing a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message, transmitting the L2 and/or L3 multicast operation capability towards the first or third network node, receiving a control message from the first or third network node, wherein the control message includes an indication to the user equipment to activate the L2 and/or L3 multicast operation depending on its capability, and activating the L2 and/or L3 multicast operation based on the control message.

Example 98: An example apparatus includes means for transmitting, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell; means for, in response to the first network node hosting at least the cell also hosting at least one assisting cell, transmitting a message comprising a radio resource control payload to the first network node hosting at least the cell; and means for, in response to the first network node hosting at least the cell not hosting the at least one assisting cell, transmitting the message comprising the radio resource control payload to the first network node hosting at least the cell, and transmitting another message comprising the radio resource control payload to a second network node hosting the at least one assisting cell.

Example 99: An example apparatus includes means for receiving a configuration from a first network node or a third network node indicating that the user equipment is to support layer 2 multicast operation or layer 3 multicast operation; wherein the configuration indicates functionality for detecting a copy of a layer 2 or layer 3 message is received, and for discarding the copy; wherein the copy is received from a non-serving cell; means for activating in downlink or uplink or both, layer 2 multicast operation or layer 3 multicast operation, based on the received configuration; means for receiving multicast data, and processing the multicast data; and means for transmitting either an acknowledgement or negative acknowledgement whether the multicast data was successfully received and processed; wherein the acknowledgement or negative acknowledgement is transmitted to the first network node, a second network node, or the third network node; wherein the first network node is hosting a serving cell, and the second network node is hosting at least one assisting cell.

Example 100: An example apparatus includes means for storing a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message, means for transmitting the L2 and/or L3 multicast operation capability towards the first or third network node, means for receiving a control message from the first or third network node, wherein the control message includes an indication to the user equipment to activate the L2 and/or L3 multicast operation depending on its capability, and means for activating the L2 and/or L3 multicast operation based on the control message.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations may be appended together or with other words/characters, by e.g. using a dash/hyphen, as for example in gNB-CU-CP formed by appending abbreviations gNB and CU-CP, or by appending an ‘s’ to an acronym for plurality e.g. PDUs):
3G third generation
3GPP third generation partnership project
4G fourth generation
5G fifth generation
5GC 5G core network
6G sixth generation
AI artificial intelligence
ACK acknowledgement
AMF access and mobility management function
AS access stratum
ASIC application-specific integrated circuit
BBU baseband unit
BCCH broadcast control channel
C control or control plane
CE control element
Comp. compression
CP control plane
C-plane control plane
CPU central processing unit
C-RAN centralized, clean, cloud, and/or collaborative RAN
CU central unit or centralized unit
CU-CP central unit control plane
CU-UP central unit user plane
DC dual connectivity
DCI downlink control information
DL downlink
DSP digital signal processor
DU distributed unit
E1 interface connecting two disaggregated user and control planes
eNB evolved Node B (e.g., an LTE base station)
EN-DC E-UTRA-NR dual connectivity
en-gNB node providing NR user plane and control plane protocol terminations towards the UE, and acting as a secondary node in EN-DC
E-UTRA evolved universal terrestrial radio access, i.e., the LTE radio access technology
F1 interface between CU and DU, e.g. F1-C or F1-U
F1AP F1 application protocol
feMIMO further enhanced MIMO
FPGA field-programmable gate array
gNB base station for 5G/NR, i.e., a node providing NR user plane and control plane protocol terminations towards the UE, and connected via the NG interface to the 5GC
HO handover
HSDPA high-speed downlink packet access
HSPA high speed packet access
ID identifier
IE information element
I/F interface
I/O input/output
IoT internet of things
L1 layer 1
L2 layer 2
L3 layer 3
LCID logical channel ID
LMF location management function
LTE long term evolution (4G)
M2M machine to machine
MAC medium access control
MF multiflow
MIMO multiple input multiple output
ML machine learning
MME mobility management entity
MN master node
MR multi-RAT
mTRP multiple TRP
N multiple (e.g. N×)
NACK negative acknowledgement
NCE network control element
ng or NG new generation
ng-eNB new generation eNB
NG-RAN new generation radio access network
NR new radio (5G)
N/W network
opt optional
O-RAN open radio access network
PCCH paging control channel
PCI physical cell ID
PDCP packet data convergence protocol
PDCP(c) PDCP control plane
PDCP(u) PDCP user plane
PDU packet data unit
PHY physical layer
PS packet scheduler
QoS quality of service
RAN radio access network
RAN #radio layer #, or 3GPP Technical Specification Group Radio Access Network WG #(e.g. RAN1)
RAT radio access technology
R-bit reserved bit
RCC radio resource control connection
RE radio equipment
REC radio equipment controller
Rel release
RF radio frequency
RLC radio link control
RRC radio resource control (protocol)
RRH remote radio head
RRU remote radio unit
RU radio unit
Rx receive or receiver or reception
SDAP service data adaptation protocol
segm. segmentation
SFDC single frequency dual cell (also SF-DC)
SGW serving gateway
SMF session management function
SN secondary node
SON self-organizing/optimizing network
TCI transmission configuration indicator
TR technical report
TRP transmission and reception point
TS technical specification
Tx transmit or transmitter or transmission
UE user equipment (e.g., a wireless, typically mobile device)
UL uplink
UP user plane
UPF user plane function
V version
V-RAN virtual radio access network
WG working group
WI work item
X2 interface between two radio nodes (e.g. two eNBs)
Xn interface between two NG-RAN nodes

1-42. (canceled)

43. An apparatus comprising:
at least one processor; and
at least one memory including computer program code;
wherein the at least one memory and the computer program code are configured to, with the at least one processor, cause the apparatus at least to:
transmit, from a third network node to a first network node hosting at least a cell, an indication or configuration of whether activation of multicast operation is applicable to layer 3 control plane signaling, layer 2 control plane signaling, or both layer 3 control plane signaling and layer 2 control plane signaling at the first network node hosting at least the cell;
in response to the first network node hosting at least the cell also hosting at least one assisting cell, transmit a message comprising a radio resource control payload to the first network node hosting at least the cell; and
in response to the first network node hosting at least the cell not hosting the at least one assisting cell, transmit the message comprising the radio resource control payload to the first network node hosting at least the cell, and transmit another message comprising the radio resource control payload to a second network node hosting the at least one assisting cell.

44. The apparatus of claim 43, wherein the at least one memory and the computer program code are further configured to, with the at least one processor, cause the apparatus at least to:
determine a number of copies of a message to send to a user equipment.

45. The apparatus of claim 43, wherein the at least one memory and the computer program code are further configured to, with the at least one processor, cause the apparatus at least to:
determine that the multicast operation is applicable to layer 3 signaling.

46. The apparatus of claim 43, wherein the configuration and indication are transmitted over an interface between the third network node and the first network node hosting at least the cell.

47. The apparatus of claim 43, wherein the indication or configuration of whether activation of multicast operation is applicable is associated with a set of user equipments for which the multicast operation is to be applied.

48. The apparatus of claim 43, wherein the indication or configuration of whether activation of multicast operation is applicable is not associated with a set of user equipments and is generally associated with any user equipment that supports multicast operation.

49. The apparatus of claim 43, wherein the indication of whether activation of multicast operation is applicable is transmitted as an on or off flag, and the configuration of whether activation of multicast operation is applicable is transmitted as a setup message over an interface between the third network node and the first network node hosting at least the cell.

50. The apparatus of claim 43, wherein the at least one memory and the computer program code are further configured to, with the at least one processor, cause the apparatus at least to:
receive an indication of support of multicast operation from the first network node hosting at least the cell.

51. The apparatus of claim 43, wherein the at least one memory and the computer program code are further configured to, with the at least one processor, cause the apparatus at least to:
transmit a copy of control plane multicast data of a serving cell to the second network node hosting the at least one assisting cell.

52. The apparatus of claim 43, wherein the at least one memory and the computer program code are further configured to, with the at least one processor, cause the apparatus at least to:
receive feedback, an acknowledgement or negative acknowledgement regarding transmission, receipt, or processing of multicast data from the first network node hosting at least the cell, the second network node hosting the at least one assisting cell, and/or the user equipment; and
learn, based on an artificial intelligence or machine learning method, at least one criterion to activate multicasting using the acknowledgement or negative acknowledgement;
wherein the at least one criterion includes at least one of specific message type, type of user equipments, or characteristics of cells.

53. The apparatus of claim 43, wherein the at least one memory and the computer program code are further configured to, with the at least one processor, cause the apparatus at least to:
receive a first notification that the radio resource control payload was transmitted to the user equipment from the first network node hosting at least the cell; and
receive a second notification that the radio resource control payload was transmitted to the user equipment from the second network node hosting the at least one assisting cell; and
learn, based on an artificial intelligence or machine learning method, when to activate multicasting using the first notification and the second notification.

54. The apparatus of claim 43, wherein the at least one memory and the computer program code are further configured to, with the at least one processor, cause the apparatus at least to:
determine success of at least one multicast transmission.

55. The apparatus of claim 43, wherein:
the message comprising the radio resource control payload transmitted to the first network node hosting at least the cell indicates that multicast operation is applicable to layer 3 signaling; and
the another message comprising the radio resource control payload transmitted to the second network node hosting the at least one assisting cell indicates that multicast operation is applicable to layer 3 signaling.

56. The apparatus of any one of claim 43, wherein the at least one memory and the computer program code are further configured to, with the at least one processor, cause the apparatus at least to:
detect duplicate copies of multiple received messages; and
discard at least one of the multiple received messages.

57. A user equipment comprising:
at least one processor; and
at least one memory including computer program code;
wherein the at least one memory and the computer program code are configured to, with the at least one processor, cause the user equipment at least to:
receive a configuration from a first network node or a third network node indicating that the user equipment is to support layer 2 multicast operation or layer 3 multicast operation;
wherein the configuration indicates functionality for detecting a copy of a layer 2 or layer 3 message is received, and for discarding the copy;
wherein the copy is received from a non-serving cell;
activate in downlink or uplink or both, layer 2 multicast operation or layer 3 multicast operation, based on the received configuration;
receive multicast data, and process the multicast data; and
transmit either an acknowledgement or negative acknowledgement whether the multicast data was successfully received and processed;
wherein the acknowledgement or negative acknowledgement is transmitted to the first network node, a second network node, or the third network node;
wherein the first network node is hosting a serving cell, and the second network node is hosting at least one assisting cell.

58. The user equipment of claim 57, wherein the configuration is received with at least one of:
a radio resource control transaction identifier;
a medium access control element;
a medium access control logical channel identifier; or
at least one packet header element.

59. The user equipment of claim 57, wherein the at least one memory and the computer program code are further configured to, with the at least one processor, cause the user equipment at least to:
receive, from the first network node hosting the serving cell, a medium access control element handover message associated with a serving cell related to layer 2 signaling, or a radio resource control message associated with the serving cell related to layer 3 signaling.

60. The user equipment of claim 57, wherein the at least one memory and the computer program code are further configured to, with the at least one processor, cause the user equipment at least to:
receive, from the first network node hosting the serving cell, a medium access control element handover message associated with the at least one assisting cell related to layer 2 signaling, or a radio resource control message associated with the at least one assisting cell related to layer 3 signaling.

61. The user equipment of claim 57, wherein the at least one memory and the computer program code are further configured to, with the at least one processor, cause the user equipment at least to:
receive, from the second network node hosting the at least one assisting cell, a radio resource control message associated with the at least one assisting cell related to layer 3 signaling.

62. The user equipment of claim 57, wherein the at least one memory and the computer program code are further configured to, with the at least one processor, cause the user equipment at least to:
receive an original message from the first network node hosting the serving cell, and subsequently receive a duplicate message from the second network node hosting the at least one assisting cell;
process the original message, and send a first acknowledgement to the first network node hosting the serving cell; and
discard the duplicate message, and send a second acknowledgement to the second network node hosting the at least one assisting cell.

63. The user equipment of claim 57, wherein the at least one memory and the computer program code are further configured to, with the at least one processor, cause the user equipment at least to:
receive a duplicate message from the second network node hosting the at least one assisting cell, and subsequently receive an original message from the first network node hosting the serving cell;
process the duplicate message, and send a first acknowledgement to the second network node hosting the at least one assisting cell; and
discard the original message, and send a second acknowledgement to the first network node hosting the serving cell.

64. The user equipment of claim 63, wherein the at least one memory and the computer program code are further configured to, with the at least one processor, cause the user equipment at least to:
indicate to both the second network node hosting the at least one assisting cell and the first network node hosting the serving cell that the duplicate message was received before the original message.

65. The user equipment of claim 57, wherein the at least one memory and the computer program code are further configured to, with the at least one processor, cause the user equipment at least to:
receive a duplicate message from the second network node hosting the at least one assisting cell, and not receive an original message from the first network node hosting the serving cell; and
process the duplicate message, and send an acknowledgement to the first network node hosting the at least one assisting cell that the duplicate message was processed.

66. The user equipment of claim 65, wherein the at least one memory and the computer program code are further configured to, with the at least one processor, cause the user equipment at least to:
indicate to both the second network node hosting the at least one assisting cell and the first network node hosting the serving cell that the original message was not received.

67. The user equipment of claim 57, wherein the at least one memory and the computer program code are further configured to, with the at least one processor, cause the user equipment at least to:
transmit an acknowledgement report to the third network node, the acknowledgement report configured to be used with at least one artificial intelligence or machine learning algorithm to determine when to enable multicasting or determine whether a set of one or more network nodes nodes are eligible for multicasting.

68. The user equipment claim 57, wherein the configuration indicates a data direction for the user equipment as being uplink, downlink, or both uplink and downlink.

69. The user equipment of claim 57, wherein the at least one memory and the computer program code are further configured to, with the at least one processor, cause the user equipment at least to:
receive medium access control information indicating whether signaling received is duplicate signaling.

70. The user equipment of claim 57, wherein the acknowledgement or negative acknowledgement of whether the multicast data was successfully received and processed is transmitted either to:
at least one of the first network node or the second network node when the multicast data was received with layer 2 signaling; or
the third network node when the multicast data was received with layer 3 signaling.

71. A user equipment comprising:
at least one processor; and
at least one memory including computer program code;
wherein the at least one memory and the computer program code are configured to, with the at least one processor, cause the user equipment at least to:
store a L2 and/or L3 multicast operation capability, wherein a L2 multicast operation enables the user equipment to receive a first L2 message from a first network node, and a second L2 message from a second network node, wherein a payload of second L2 message is a duplicate of a payload of the first message, and wherein a L3 multicast operation enables the user equipment to receive a third L3 message from a third network node, and a fourth L3 message from a fourth network node, wherein a payload of fourth L3 message is a duplicate of a payload of third message,
transmit the L2 and/or L3 multicast operation capability towards the first or third network node, receive a control message from the first or third network node, wherein the control message includes an indication to the user equipment to activate the L2 and/or L3 multicast operation depending on its capability, and
activate the L2 and/or L3 multicast operation based on the control message.
